(19) United States
(12) Patent Application Publication
(10) Pub. No.: US 2014/0143025 A1
(43) Pub. Date: May 22, 2014

(54) SYSTEM AND METHOD FOR MANAGING CUSTOMER EXPERIENCE WHEN PURCHASING A PRODUCT OR SERVICE

(71) Applicant: Maritz Holdings Inc., (US)

(72) Inventors: David Fish, Torrance, CA (US); Jason Scheil, Marina del Rey, CA (US); Edward Stalling, Missoula, MT (US); Daniel Korzeniewski, Maumee, OH (US); Karel Mette, Hamburg (DE); Jennifer Passini, Fenton, MO (US); Terry Millard, Fenton, MO (US); Michael Henderson, Long Beach, CA (US)

(73) Assignee: MARITZ HOLDINGS INC., Fenton, MO (US)

(21) Appl. No.: 13/766,906

(22) Filed: Feb. 14, 2013

Related U.S. Application Data
(60) Provisional application No. 61/601,419, filed on Feb. 21, 2012.

(51) Int. Cl. G06Q 10/06; G06Q 30/02

(52) U.S. Cl. CPC G06Q 10/06398; G06Q 30/0282
USPC 705/7.42

(57) ABSTRACT

A system is provided for use by managers, employees, and customers to analyze the experience of customers involving the purchase of products/services at a facility to determine individual employee performance, team performance, and corporate performance. The system includes a database populated with facility information, employee information, product information, and transactional information. A processor is connected to the database to access sales information regarding the products/services sold, product information identifying products/services available for purchase, customer feedback information regarding commercial transactions, employee information regarding the identity and performance of each employee over a period of time, and facility information regarding an identity of the facility and customer satisfaction toward the facility. The processor executes computer-executable instructions for presenting to a unit level or corporate manager an integrated interactive display that provides a facility performance interface, an employee evaluation interface, a customer management interface, and a priority list interface.

### BACKGROUND OF THE INVENTION

The present invention generally relates to systems and methods for a manager of a team of employees selling products/services to monitor the experience of customers purchasing the product/service at a facility in order to analyze the performance of the employees and the team. It also relates to allowing employees to track their performance. In particular, the present invention provides the manager with the capability to access specific information required to identify trends and to diagnose problems with a particular customer, a particular facility, a particular employee, or a particular region.

The measurement of employee performance and customer experience is typically difficult to understand and difficult to manage because the vast amount of data generated by facilities selling products/services to customers. Available online tools for the analytical processing and sorting of the myriad of data, such as client defined surveys, has not provided the manager effective tools to improve the performance of their teams based on typical customer feedback.

The customer experience measurement may be determined and utilized at different levels: at a unit level (e.g., a facility, a store level) and at a regional or national (e.g., even global) level. For instance, the performance of a particular facility, the performance of an employee, specific actions associated with customer follow-up, and people and processes that impact critical areas for a particular facility should be considered and measured.

### SUMMARY

A system for use by managers, employees, and customers is configured to analyze the experience of customers in commercial transactions involving the purchase of products/services at a facility. The system combines customers' experiences to result in individual employee performance and employee team performance related to the commercial transactions. A database is populated with transactional sales information for the products/services sold. Product information identifies (1) products/services available for purchase at each facility, (2) customer feedback information regarding commercial transactions involving the facility, and (3) facility information regarding an identity of the facility and a customer satisfaction toward the facility. A processor is connected to and accesses the database, and is configured for executing computer executable instructions stored in a tangible, non-transitory memory for presenting an integrated, interactive display interface. The display interface includes a facility performance interface and a priority list interface. An incentive analytic engine comprises a plurality of predictor model instructions for processing the customer feedback for the facility to determine performance metrics of the facility based on a plurality of team metrics over a period of time. The manager of the facility can access the facility performance interface comprising a dashboard for graphically displaying the determined performance metrics. An action plan analytic engine comprises a plurality of unit action plan instructions for processing the customer information based on importance rules to determine a plurality of ranked attributes. The manager of the facility accesses the priority list interface comprising a dashboard for graphically displaying the determined ranked attributes.

One or more computer-readable storage media have computer-executable components stored on the tangible to provide a system for use by managers, employees, and customers to analyze the experience of customers in commercial transactions involving the purchase of products/services at a facility. The system includes a database, a processor, a facility performance interface component, an employee evaluation interface component, a customer management interface component, and a priority list interface component. The database is populated with transactional information comprising transactional sales information for the products/services sold, product information identifying products/services available for purchase at each facility, customer feedback information regarding commercial transactions involving employees made by the customer when purchasing the products/services at the facility, employee information regarding the identity of each employee at the facility and their performance for a transaction, and facility information regarding an identity of the facility and a customer satisfaction toward the facility. The processor is connected to and accesses the database and is configured for executing the computer executable components for presenting an integrated, interactive display interface. The facility performance interface component comprises a plurality of computer-executable predictor model instructions for processing the customer feedback for the facility to determine performance metrics of the facility based on a plurality of team metrics over a period of time for presenting a facility performance interface on the integrated, interactive display interface. The manager of the facility can access the facility performance interface which comprises a dashboard for graphically displaying the determined performance metrics. The employee evaluation interface component comprises a plurality of computer-executable improvement plan instructions for processing the employee information for each employee reporting to determine employee metrics in the team based on a plurality of performance criteria in selling the products/services to the customers over a period of time for presenting an employee evaluation interface on the integrated, interactive display interface. The manager of the facility accesses the employee evaluation interface which comprises a dashboard for graphically displaying the determined employee metrics. The customer management interface component comprises a plurality of computer-executable customer alert instructions for processing the product, and transactional information to determine critical customer issues based on customer feedback criteria received from customers when purchasing the products/services for presenting a customer management interface on the integrated, interactive display interface. The manager of the facility accesses the customer management interface which comprises a dashboard for graphically displaying the determined critical customer issues. The priority list interface component comprises a plurality of computer-executable unit action plan instructions for processing the customer information based on priority rules to determine a plurality of ranked attributes for the team for presenting a priority list interface on the integrated, interactive display interface. The manager of the facility accesses the priority list interface which comprises a dashboard for graphically displaying the determined ranked attributes.

One or more computer-readable storage media have computer-executable instructions stored on the tangible, non-transitory media for use with a system including a database populated with (1) transactional information comprising transactional sales information for products/services sold, (2) product information identifying products/services available for purchase at various facilities, (2) customer feedback information regarding commercial transactions involving employees made by customers when purchasing the products/services at a facility, (4) employee information regarding the identity of each employee at a facility and their performance over a period of time, and (5) facility information regarding an identity of a facility and a customer satisfaction toward the facility. The system includes a processor, an incentive analytic engine, an improvement analytic engine, a customer alert analytic engine, and an action plan analytic engine. The processor is connected to and accesses the database, and is configured for executing the computer executable instructions for presenting an integrated, interactive display interface. The display interface includes a facility performance interface, an employee evaluation interface, a customer management interface, and a priority list interface. The incentive analytic engine comprises a plurality of predictor model instructions for processing the customer feedback for each facility to determine performance metrics of the facility based on a plurality of team metrics over a period of time. The manager of the facility can access the facility performance interface which comprises a dashboard for graphically displaying the determined performance metrics. The improvement analytic engine comprises a plurality of improvement plan instructions for processing the employee information for each employee to determine employee metrics in the team based on a plurality of performance criteria in selling the products/services to the customers over a period of time. The manager of the facility accesses the employee evaluation interface which comprises a dashboard for graphically displaying the determined employee metrics. The customer alert analytic engine comprises a plurality of customer alert instructions for processing the product and transactional information to determine critical customer issues based on customer feedback criteria received from customers when purchasing the products/services. The manager of the facility accesses the customer management interface which comprises a dashboard for graphically displaying the determined critical customer issues. The action plan analytic engine comprises a plurality of unit action plan instructions for processing the customer information based on priority rules to determine a plurality of ranked attributes for the team. The manager of the facility accesses the priority list interface which comprises a dashboard for graphically displaying the determined ranked attributes.

Other objects and features will be in part apparent and in part pointed out hereinafter.

### BRIEF DESCRIPTION OF THE DRAWINGS

FIG. 1 is a block diagram of a system according to one embodiment of the invention.

FIG. 2 is a block diagram illustrating the Integrated, Interactive Display 22 of FIG. 1 accessing various detailed reports and interactive tools, according to one embodiment of the invention.

FIG. 3 is an illustration of an Integrated, Interactive Display 22 showing a facility performance interface 64, an employee evaluation interface 66, a customer management interface 68, and a priority list interface 70 organized in four quadrants according to one embodiment of the invention.

FIG. 4 illustrates selection of a “performance” pull-down menu from the Integrated, Interactive Display 22 shown in FIG. 3.

FIG. 5 illustrates selection of a “Customers” pull-down menu from the Integrated, Interactive Display 22 shown in FIG. 3.

FIG. 6 illustrates selection of a “Employees” pull-down menu from the Integrated, Interactive Display 22 shown in FIG. 3.

FIG. 7 illustrates selection of a “Unit” pull-down menu from the Integrated, Interactive Display 22 shown in FIG. 3.

FIG. 7A illustrates selection of a “Tools” pull-down menu from the Integrated, Interactive Display 22 shown in FIG. 3.

FIG. 8 is an illustration of a facility performance interface in the first quadrant of the Integrated, Interactive Display 22 of FIG. 3 graphically displaying performance metrics for the facility, according to one embodiment of the invention.

FIG. 9 illustrates a “performance” report for a selected facility accessible by the user by selecting performance from the performance pull-down menu shown in FIG. 4 or by the user selecting a “View Report” from the performance metric dashboard of FIG. 8.

FIG. 10 illustrates a “predictor model Tool” for a selected unit upon the user selecting predictor model from the performance pull-down menu shown in FIG. 4.

FIG. 11 illustrates an exemplary trend line illustrating the facility ranking over time compared to a selected benchmark which is accessible by the user selecting a “trend” shown in the facility performance interface 64 shown in FIG. 3.

FIG. 11A illustrates an exemplary histogram illustrating the facility rank among peers within the given timeframe which is accessible by selecting the “rank” shown in the facility performance interface 166 shown in FIG. 9.

FIG. 12 is an illustration of the second quadrant 54 of the Integrated, Interactive Display 22 of FIG. 2 for an employee evaluation interface 66 that graphically shows a dashboard displaying employee metrics for each employee's individual performance, according to one embodiment of the invention.

FIG. 13 illustrates an exemplary Employees Report accessible by the user by selecting “Employees” from the Employees pull-down menu shown in FIG. 5, or by the user selecting a “View Report” from the employee evaluation interface 66 shown in FIG. 12.

FIG. 13A illustrates an exemplary performance plans report accessible by the user by selecting “performance plans” from the Employees pull-down menu shown in FIG. 5, or by selecting the “plan” icon next to an employee name from the Employees report shown in FIG. 13.

FIG. 14 illustrates an exemplary “performance plan” selected by a user from the “Plan” icon on the Employees Summary report of FIG. 13.

FIG. 15 is an illustration of the third quadrant 56 of the Integrated, Interactive Display 22 of FIG. 3 for a customer management interface 68 that graphically shows customer hot alert data for critical customer issues, according to one embodiment of the invention.

FIG. 16 illustrates “Surveys” accessible by the user selecting Surveys from the “Customers” pull-down menu shown in FIG. 5 or by the user selecting a “View Report” from the customer management interface 68 shown in FIG. 15.

FIG. 16A illustrates a survey detail display accessible by the user selecting of a “Customer Name” of a particular customer from Surveys as shown in FIG. 16.

FIG. 17 illustrates a case management display accessible by the user selecting of “Manage Case” for a particular customer from a Survey Detail report shown in FIG. 16A and which the user can assign a particular customer alert to an employee to process.

FIG. 17A illustrates the Customer Voice report accessible by the user selecting of “Customer Voice” from the Customers menu in FIG. 5.

FIG. 17B illustrates an alternate view of the Customer Voice report accessible by the user selecting of “Cloud” from the default Customer Voice view menu in FIG. 17A.

FIG. 17C illustrates the Comments report accessible by the user selecting of “Comments” from the Customers menu in FIG. 5.

FIG. 18 is an illustration of the fourth quadrant 58 of the Integrated, Interactive Display 22 of FIG. 3 for a priority list interface 70 that graphically shows unit action plan data, according to one embodiment of the invention.

FIG. 18A illustrates a Critical Items Dashboard report that is accessible by the user selecting of “Critical Items” from the Unit pull-down menu shown in FIG. 7, according to one embodiment of the invention.

FIG. 19 illustrates a plurality of coded comments where each coded comment has a color (e.g., red/green/black) and an associated number of surveys accessible to the user, according to one embodiment of the invention.

FIG. 20 illustrates a performance of a plurality of employees based on a color (e.g., red/green/black) and font size along with a respective number of customer reviews accessible by the user selecting of the “Critical Items” from the Unit pull-down menu shown in FIG. 7, according to one embodiment of the invention.

FIG. 21 illustrates a list of in-process or completed action plans displayed when a user selects “Action Plans” from the Unit pull-down menu shown in FIG. 7.

FIG. 22 is an exemplary illustration of a user managing an action plan using the Action Plan tool. It is accessed by selecting the Create/Edit Action Plan button from the Critical Items Dashboard shown in FIG. 18A.

FIG. 22A illustrates the Disposition report accessible by the user selecting of “Disposition” from the Tools menu in FIG. 7A.

FIG. 22B illustrates the Response Distribution report accessible by the user selecting of “Response Distribution” from the Tools menu in FIG. 7A.

FIG. 22C illustrates the Custom Comparators report accessible by the user selecting of “Custom Comparators” from the Tools menu in FIG. 7A.

FIG. 22D is an exemplary illustration of a user creating a custom comparator using the Modify Comparator Set function. It is accessed by selecting the Create/Modify Comparator button from the Custom Comparator view shown in FIG. 22C.

FIG. 23 illustrates the a plurality of interfaces for a plurality of facilities in a region organized in four quadrants on the Integrated, Interactive Display 22 of FIG. 3, according to one embodiment of the invention.

FIG. 24 is an illustration of a regional performance interface in the first quadrant of the integrated, interactive display of FIG. 23 graphically showing a dashboard displaying performance metrics for a region, according to one embodiment of the invention.

FIG. 25 illustrates the relative performance of multiple units located in multiple regions by the size and shading of each cell. It is available to a user by selecting the “performance” from a performance pull-down menu and by selecting the treemap icon for a specific performance attribute.

FIG. 26 is an illustration of a unit evaluation interface in the second quadrant of the Integrated, Interactive Display of FIG. 23 graphically showing a “heatmap” illustrating the performance of specific facilities in a plurality of categories by the shading of the cell and an associated metric for a region.

FIG. 27 illustrates the relative performance of a plurality of facilities identified by region in a plurality of categories which can be shown to a user by selecting a “Heatmap” from the Units drop-down menu or by selecting “View Report” from the unit evaluation interface of FIG. 26.

FIG. 28 illustrates a unit management interface in the third quadrant of the Integrated, Interactive Display shown in FIG. 23, which provides a percent incidence of hot alerts received for a plurality of units/facilities within a particular region and the average number of days each facility took to resolve customer issues, according to one embodiment of the invention.

FIG. 28A illustrates a Alert Summary report that is accessible by the user selecting of “Alerts” from the Customers pull-down menu or by selecting View Report from the display in FIG. 28.

FIG. 29 illustrates a regional priority list interface in the fourth quadrant of the Integrated, Interactive Display of FIG. 23 graphically showing a dashboard illustrates a bar graph of critical areas of concern for a particular region.

FIG. 29A illustrates the corporate action plan by question report listing each of the facilities (e.g., units) in a region and illustrating the steps in the action plan process that have been completed toward meeting a target date of completion.

FIG. 30 illustrates selection of an “Analyze” pull-down menu from the integrated, interactive display 22 shown in FIG. 23. For example, selecting “Tabulation” from this menu launches an outside software application, “Capella Tabulation”—a cross-tabulation tool that uses the same dataset as the invention.

Corresponding reference characters indicate corresponding parts throughout the drawings.

### DETAILED DESCRIPTION

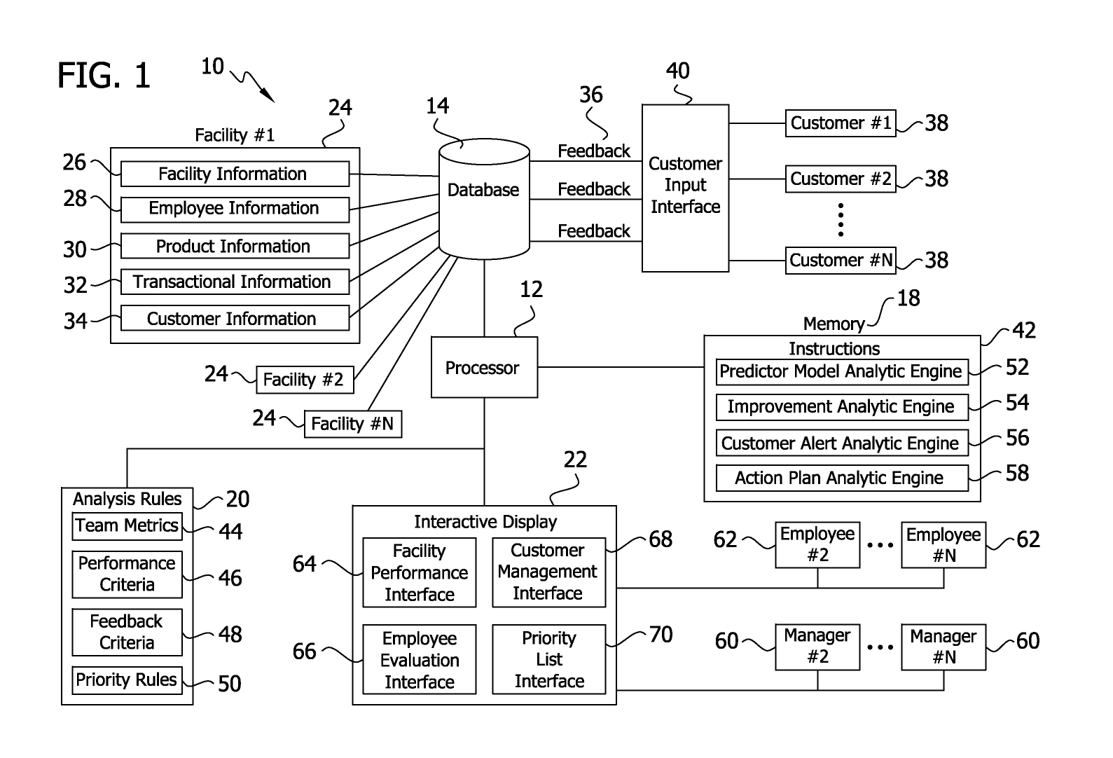

FIG. 1 is a block diagram of a system 10 according to one embodiment of the invention for use by employees, managers (e.g., the manager analyzes the experience of customers in commercial transactions involving the purchase of products/services at various facilities). The system 10 combines employee performance and customers' experiences during commercial transactions to provide a unit level manager or a regional manager various metrics associated with the performance of a particular store/region (e.g., a facility), for example, metrics related to customer feedback, employee performance metrics, and process improvement metrics for the facility. As used herein, instructions and/or rules mean computer executable instructions.

System 10 includes a processor 12 connected to a database 14, a set of computer-executable instructions stored in a memory 18, a plurality of analysis rules 20, and an interactive display 22. The database 14 stores information from multiple facilities 24. As shown, there may be more than one facility 24 (e.g., Facility #1, Facility #2, Facility #N). For example, the database 14 stores facility information 26 regarding an identity of a particular facility; employee information 28 regarding the identity of each employee at the facility and their performance over a period of time; product information 30 identifying products/services available for purchase at each facility; transactional information 32 regarding the amount of product/services sold, metrics regarding sales quota, and the like; and customer information 34 such as a customer's identity, e-mail address and other particulars.

In addition, the database 14 is populated with customer feedback information 36 regarding a commercial transaction made by the customer, via survey, after purchasing a product/service at one of the facilities 24. For example, a customer who has purchased a product/service at a facility 24 can access a customer interface 40 through various modalities (e.g., telephone, website) to provide feedback 36 (e.g., via surveys) regarding the commercial transaction. In general, as used herein, an interface is a component of computer executable instructions stored in a tangible, non-transitory medium and executed by the processor 12 to present a display of information related to the interface allowing someone to view and/or interact with the presented information.

The processor 12 executes computer-executable instructions that are stored in the memory 18, which instruct the processor 12 to utilize the facility information 26, employee information 28, product information 30, and transactional information 32 for each facility 24 in order to generate invitations for customers 38 to respond to surveys 40 regarding their transactions. For example, processor 12 executes the computer-executable instructions for processing the facility data 24 to determine which of the facility's customers 38 will receive a survey. The customer feedback 36 is stored in the database 14 and related to the customer information 34 identifying a particular customer 38.

Further, the processor 12 executes computer-executable instructions for processing facility information 26 to determine the performance of a team at a facility 24 based on team metrics 44, which evaluates the customer feedback 36 regarding the facility 24 when purchasing the products/services from the facility 24. An exemplary list of team metrics 44 comprises a ranking for the facility of the supervisor relative to other facilities, a ranking of all the salespersons in the supervisor's team relative to other salespersons at other facilities, a customer rating for the facility based on a plurality of customer ratings from customers that have purchased a product/service at the facility relative to a customer rating for other facilities, a customer payment experience rating for the facility based on a plurality of customer payment ratings from customers that have purchased a product/service at the facility relative to the a customer payment experience rating for other facilities, a customer product/service delivery rating for the facility based on a plurality of customer product/service delivery ratings from customers that have purchased a product/service at the facility relative to a customer product/service delivery rating for other facilities, a customer likely to return rating for the facility based on a plurality of customer likely to return ratings from customers that have purchased a product/service at the facility relative to a customer likely to return rating for other facilities, a customer acquisition rating based on a rating for ease of purchase, a rating for time to pay, and a rating for price fairness when the customer purchased a product/service at the facility, and a customer overall satisfaction rating for the facility based on a plurality of customer overall satisfaction ratings from customers that have purchased a product/service at the facility relative to a customer overall satisfaction rating for other facilities.

The processor 12, also, executes computer-executable instructions for processing employee information 28 to determine an individual employee's 62 performance reporting to a manager 60 for each facility 24 in selling the products/services to the customers over a period of time based on performance criteria 46, which evaluates the customer feedback 26 regarding the employee when purchasing the products/services from the facility 24. Furthermore, the processor 12 executes computer-executable instructions for processing product information 30 to determine critical customer issues requiring the attention of the manager 60 based on feedback criteria 48 that evaluates the customer feedback 26 regarding customer issues with products and the commercial transaction when purchasing the products/services from a facility 24. In addition, the processor 12 executes computer-executable instructions for processing transactional information 32 to determine a plurality of ranked attributes to be assigned to the team at a particular facility 24 based on a plurality of priority rules 50. The processor 12 further executes a plurality of analytic engines, stored in a fixed, tangible, non-transitory memory 18, that include computer-executable instructions to determine how the results obtained from customer feedback 36 are processed 12 according to the analysis rules 20 and are to be displayed on an interactive display 22. The analytic engines stored in memory 18 include a predictor model analytic engine 52, an improvement analytic engine 54, a customer alert analytic engine 56, and an action plan analytic engine 58. For example, the processor 12 executes the predictor model analytic engine 52, including predictor model instructions, for a manager to predict the potential change in a dependent variable (e.g., customer overall satisfaction) for a facility 24 based on a given independent variable (e.g., satisfaction with price paid for good/service). The improvement analytic engine 54, includes improvement plan instructions, when executed by processor 12 provides the manager 60 to set individualized goals for behaviors and scores to be achieved by a unit 62 over a period of time. An exemplary list of improvement plan instructions comprises instructions for the supervisor to review ratings for each employee in the team on a knowledge rating for the employee, a professionalism rating for the employee, a customer concern rating for the employee, correctness rating for the employee, a knowledge of product/service rating for the employee, a sales tactics rating for the employee, a rating for fairness in payment terms rating, a rating of an explanation of paperwork by the employee, a rating of an explanation of product features by the employee, a rating of how the employee treated customers in selling the product/service, a rating of whether the employee indicated concern for a customer finances when selling the product/service, and a rating of the employee in explaining a purchase process when selling the product/service.

The customer alert analytic engine 56 has customer alert instructions, which when executed by processor 12 permit the manager 60 to assign and track whether the employee 62 has taken particular action steps associated with a customer follow-up related to specific surveys 36. In addition, when the processor 12 executes the action plan analytic engine 66, including unit action plan instructions, the manager can assign team members tasks, review customer data related to a selected critical area, as well as identify systems, people, and processes that impact a critical area.

A manager 60 of a facility 24 (or a manager of a region) and an employee 62 can use an integrated, interactive display 22 as a portal to system 10. For instance, a manager 60 may use a computer (e.g., desktop, laptop, terminal connected to a server, and the like) to log into system 10, and the default display after entering the system 10 is a user-specific interface showing the four quadrants displayed on the integrated, interactive display 22. In an embodiment, the manager 60 accesses system 10 as a website by using an internet uniform resource locator (“URL”). The integrated, interactive display 22 includes a plurality of interfaces displayed in four quadrants. Managers 60, based on their role at the facility 24, can use the integrated, interactive display 22 to individually select a particular quadrant, for example, to determine team performance, employee performance, critical customer issues, and to prioritize tasks for the facility 24. The level of the manager 60, (e.g., unit level manager versus regional manager) will determine the access a manager 60 has to the information stored in system 10. A unit level manager will only be allowed to access information from the integrated, interactive display 22 regarding his/her particular facility 24 and regarding his/her team of employees at the facility 24. Alternatively, a regional or area manager will be able to access information for multiple facilities 24. Both types of managers (e.g., a unit level manager and a regional manager) will access the system 10 via the integrated, interactive display 22.

For instance, a unit level manager can access the integrated interactive display 22 to determine how the team is performing and what activities should be implemented to improve the customer experience when a customer purchases a product/service at the facility 24. The regional manager may use the integrated, interactive display 22 to compare how the different facilities 24 are performing on a regional or at a national level, determine which facilities 24 in a region need assistance, which facilities 24 have met their quotas/plan, and which stores need assistance in resolving customer issues. In addition, an employee 62 for a facility 24 reporting to the manager 60 (e.g., a unit level manager) can access the integrated, interactive display 22 to receive tasks/assignments assigned by the manager 60, review their individual performance over a period of time, and enter comments regarding the manager's 60 evaluation of their performance.

The integrated interactive display 22 includes a facility performance interface 64, an employee evaluation interface 66, a customer management interface 68, and a priority list interface 70 located in one of each the four quadrants for the manager 60 to access.

The manager 60, for example, may want to know the performance of a facility 24. In order to determine how a facility 24 is performing, the manager 60 can access the facility performance interface 64 displayed in one of the four quadrants on the integrated, interactive display 22. The facility performance interface 64 includes a dashboard for graphically displaying a plurality of performance metrics that are the result of aggregated customer feedback information 36 stored in the database 14 relating to the performance of the facility 24 according to the analysis rules 20. For example, the analytic engine 52, which includes a plurality of predictor model instructions executed by the processor 12 for processing the customer feedback 36 for the facility 24, determines the performance metrics for the facility 24 based on the plurality of team metrics 40 over a period of time.

Similarly, if the manager 60 wants to determine the performance of an employee 62, the manager 60 can access the employee evaluation interface 66 displayed on one of the four quadrants on the integrated, interactive display 22. The employee evaluation interface 66 includes a dashboard for graphically displaying a plurality of employee metrics for each employee 62 in a team reporting to a manager 60 of a facility 24. The employee metrics are the result of aggregated customer feedback information 36 via the customer interface 40 stored in the database 14. The employee metrics relate to the performance of the employee according to the analysis rules 20. For example, the improvement analytic engine 54, which includes a plurality of improvement plan instructions executed by the processor 12 for processing the customer feedback 36 regarding the employee 62, determines the performance of the employee in selling the products/services to the customers 38 over a period of time based on a plurality of performance criteria 46.

In addition, if the manager 60 wants to determine what customer issues are pending or need to be resolved for a particular facility 24, the manager 60 can access the customer management interface 68 displayed on one of the four quadrants on the integrated, interactive display 22. The customer management interface 68 includes a dashboard for graphically displaying a plurality of customer critical issues (e.g., hot alert data) for a manager 60 to review. The customer critical issues are a result of aggregated customer feedback information 36 garnered from surveys conducted via the customer interface 40 stored in the database 14. The customer critical issues relate to commercial transactions involving a customer at the facility 24 according to the analysis rules 20. For example, the customer alert analytic engine 56, which includes a plurality of customer alert instructions executed by the processor 12 for processing the product 30 and transactional information 32, determines the critical customer issues received from customers 38 when purchasing the products/services based on a plurality of feedback criteria 48.

Furthermore, the manager 60 can determine what areas need improvement, either for the facility 24 or for the team, by accessing the priority list interface 70 displayed on one of the four quadrants on the integrated, interactive display 22. The priority list interface 70 includes a dashboard for graphically displaying a plurality of unit action plan data relating to areas of improvement based on customer feedback 36 as well as employee and team performance at a facility 24 to the manager 60. For example, the action plan analytic engine 58, which includes a plurality of unit action plan instructions executed by the processor 12 for processing the customer information 34, determines a plurality of ranked attributes for the team based on the priority rules 50.

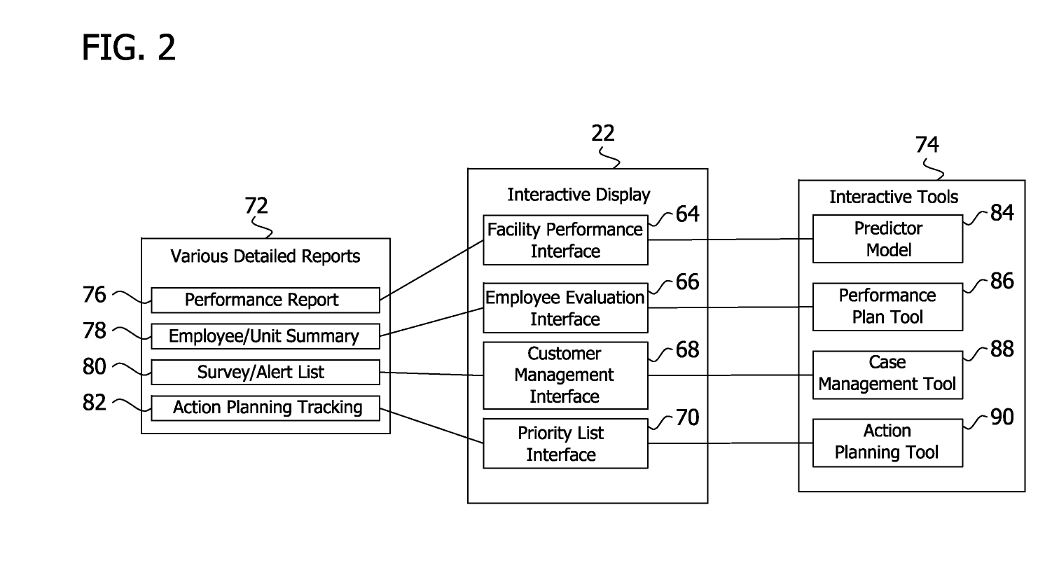

Referring now to FIG. 2, it illustrates how a unit level manager 60 can use the various interfaces of the integrated, interactive display 22 of FIG. 1 to access various detailed reports 72 and interactive tools 74. By accessing the various interfaces a manager 60 is able to determine how adjusting the score(s) for independent variable(s) will impact the results of a dependent variable from the facility performance interface 64; determine how to improve an employee's performance from the employee evaluation interface 66; be alerted to customer issues from the customer management interface 68; and create an action plan(s) for the facility 24 unit by accessing the priority list interface 70 for a particular facility 24.

For example, the manager 60 when accessing the facility performance interface 64 of the integrated, interactive display 22 can select a performance report 76, or the manager 60 can select to utilize a predictor model 84. The predictor model 84 allows a manager 60 to predict the potential change for a dependent variable (e.g., customer overall satisfaction) by adjusting score(s) for independent variables by utilizing the predictor model 84.

In addition, the manager 60 can access the employee evaluation interface 66 of the integrated, interactive display 22 to select an employee summary report 78 (e.g., a regional manager can access a unit summary report), or the manager 60 can select a performance plan tool 86. The employee evaluation interface 66 permits the employee 62 and his/her manager 60 to set individualized goals for behaviors and scores by utilizing the performance plan tool 86.

Moreover, the customer management interface 68 allows a manager 60 or an employee 62 to track action steps associated with customer follow-up related to specific feedback 36 generated by the customer during a commercial transaction at the facility 24. For instance, the manager 60 of the facility 24 can select from the customer management interface 68 at least one of survey list 80 and case management tool 88.

In addition, the priority plan interface 70 allows a manager 60 to determine critical areas by identifying items that are of high importance to the facilities' customers and low performance by the facility 24. Therefore, the manager 60 can select from the priority plan interface 70 on the integrated, interactive display 22 an action planning tracking report 82 or an action planning tool 90 to assign ranked attributes to the team.

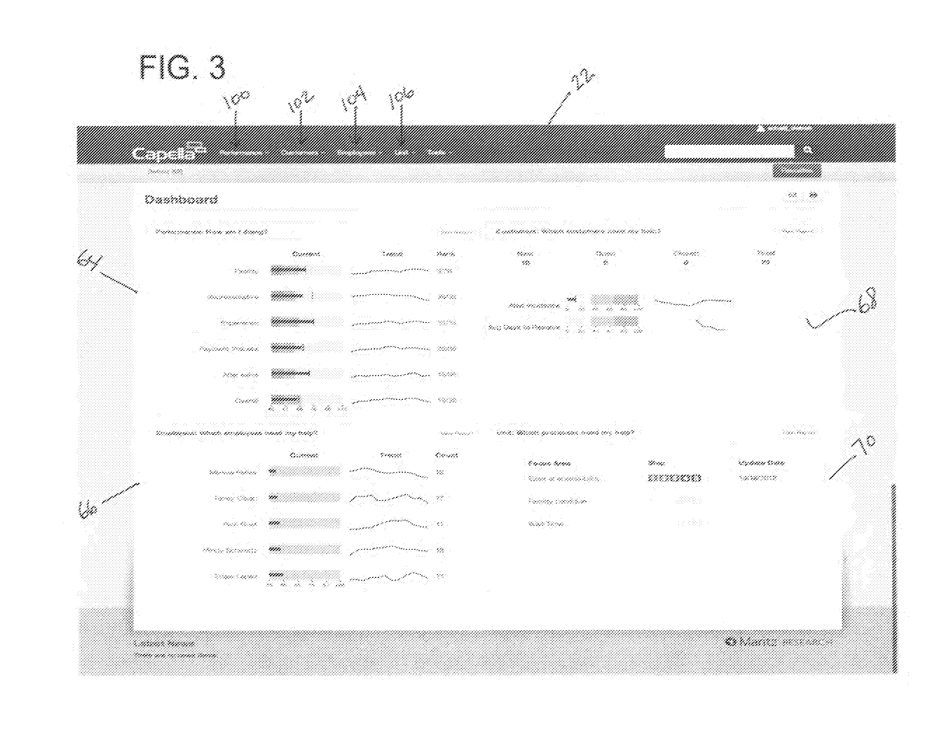

Referring now to FIG. 3, it illustrates the integrated, interactive display 22 as a portal to system 10 having a plurality of interfaces. The integrated, interactive display 22 includes the facility performance interface 64, the employee evaluation interface 66, the customer management interface 68, and the priority list interface 70, organized in four quadrants along with their respective dashboards. In one embodiment, the integrated, interactive display 22 is shown as a website. Each interface has a respective dashboard that provides to the manager 60 facility performance information for the facility 24, employee performance information for a particular employee 62, customer issues identified as new, open or pending, and a list of priority tasks.

The integrated, interactive display 22 also includes a plurality of user-selectable pull-down menus that correspond to one of the user-selectable interfaces. For example, the facility performance interface 64 has a corresponding performance 100 pull-down menu. The employee evaluation interface 66 has a corresponding Employees 104 pull-down menu. The customer management interface 68 has corresponding Customers 102 pull-down menu, and the priority list interface 70 has a corresponding Unit 106 pull-down menu.

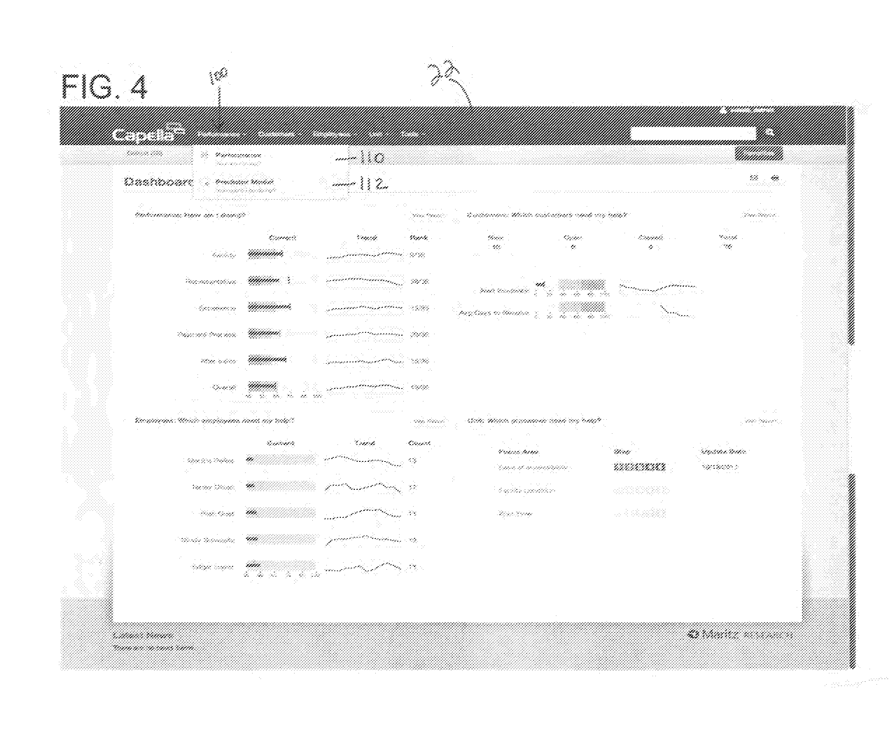

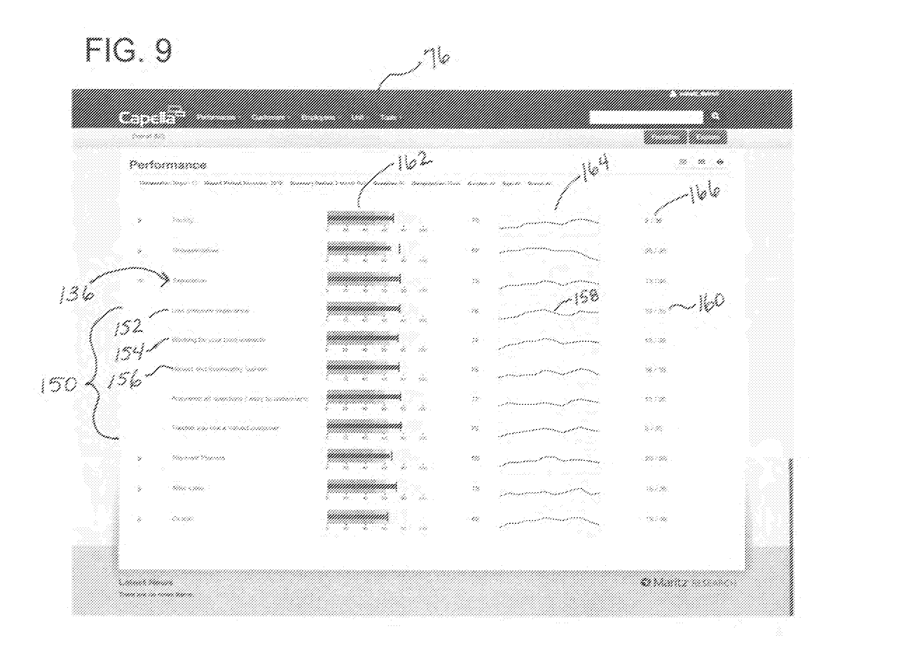

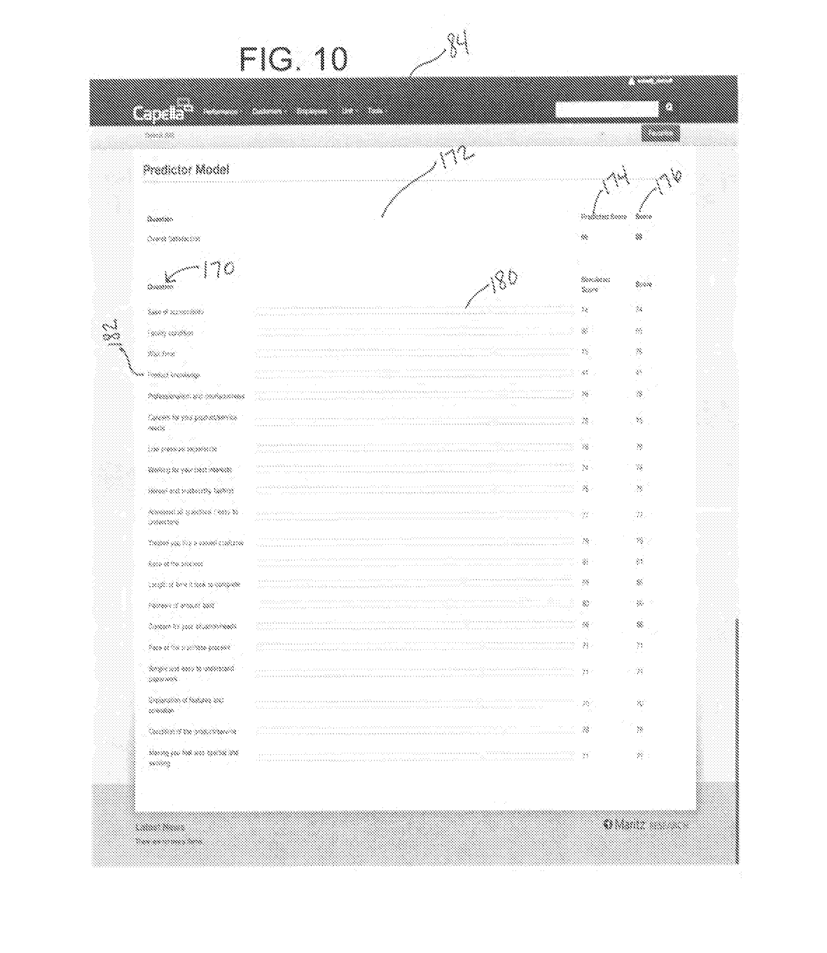

Each of the pull-down menus permits the manager 60 to select at least one of a detailed report and an interactive tool. As shown in FIG. 4, the performance 100 pull-down menu provides the manager 60 the ability to select a performance menu 110 and a predictor model menu 112. When the manager 60 selects the performance menu 110, the manager is presented with the performance report 76 (shown in FIG. 9). Alternatively, when the manager 60 selects the predictor model menu 112, the manager 60 is presented with the predictor model 84 (shown in FIG. 10).

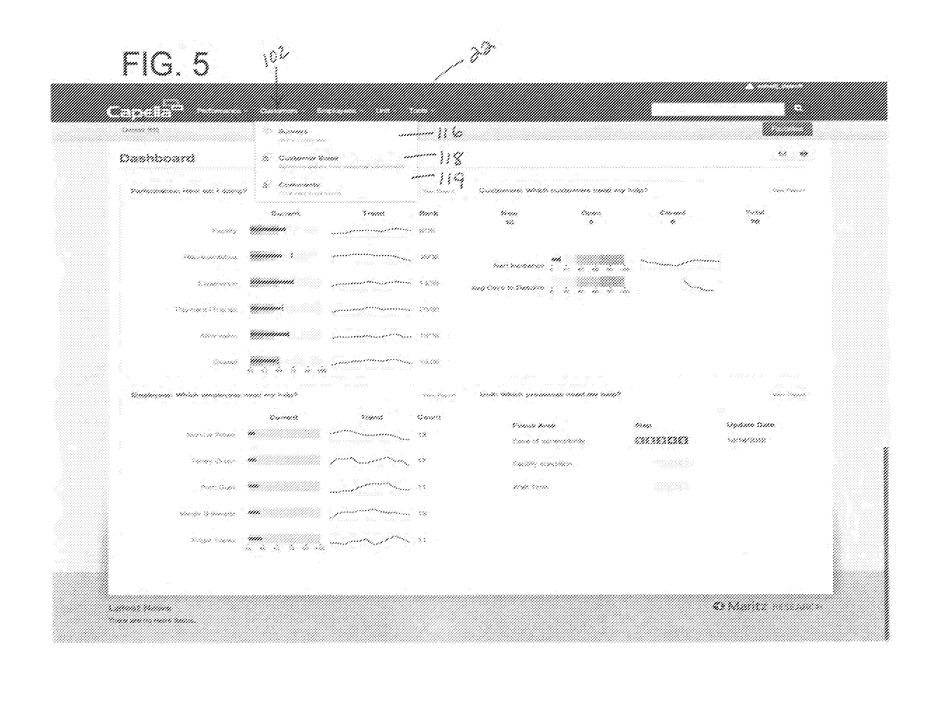

As shown in FIG. 5, the Customers 102 pull-down menu provides the manager 60 the ability to select a Surveys menu 116, a Customer Voice menu 118, and a Comments menu 119. When the manager 60 selects the Surveys menu 116, the manager is presented with the survey list 80. When the manager 60 selects the Customer Voice menu 118, the manager 60 is presented with the Customer Voice report 89. When the manager 60 selects the Comments menu 119, the manager 60 is presented with the Comments report 91.

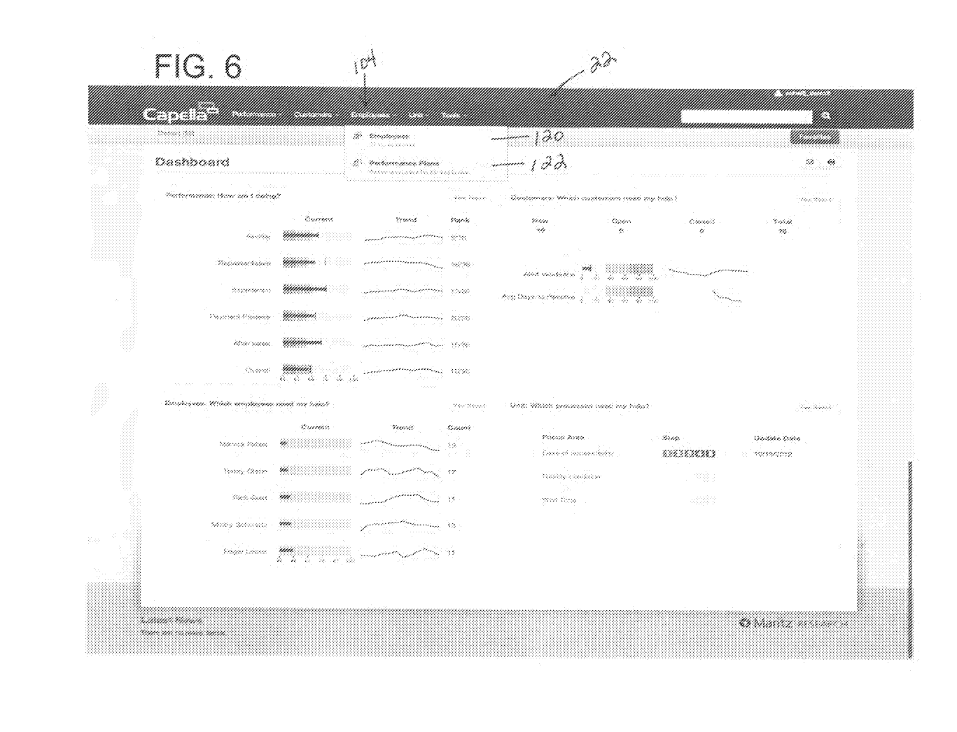

As shown in FIG. 6, the Employees 104 pull-down menu provides the manager 60 the ability to select an Employees Summary menu 120 and a performance plan Tool menu 122. When the manager 60 selects the Employees Summary menu 120, the manager is presented with the employee summary report 78. Alternatively, when the manager 60 selects the performance plan Tool menu 122, the manager 60 is presented with the performance plan tool 86.

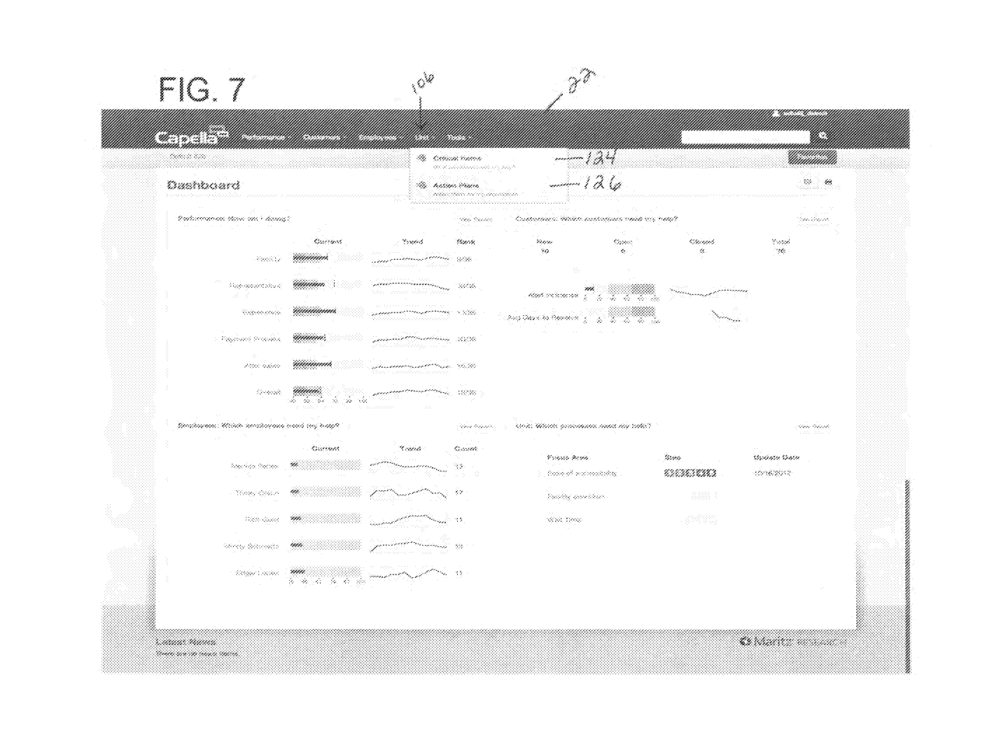

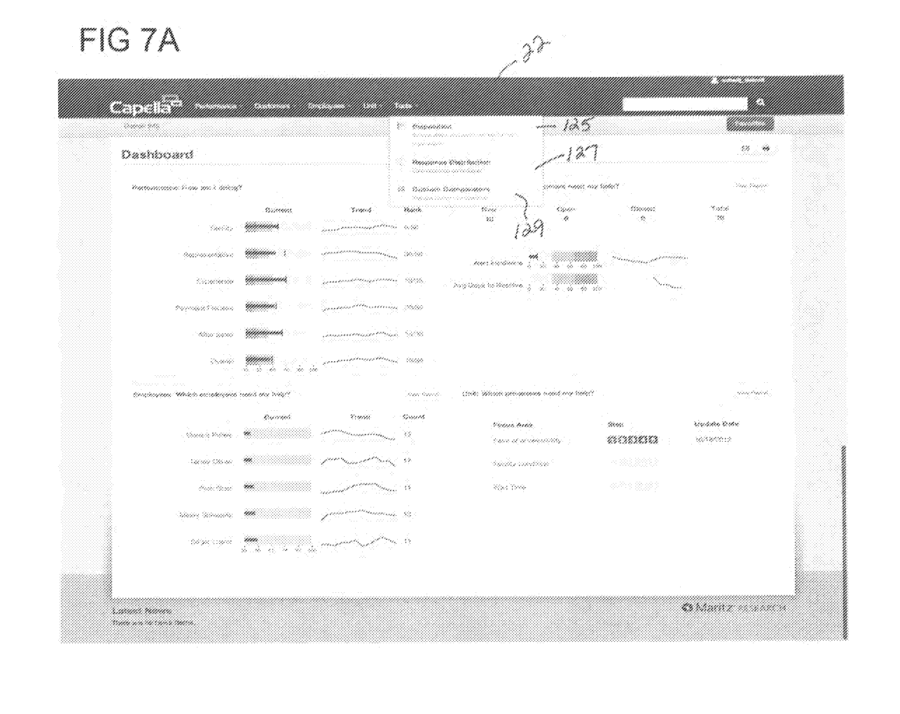

As shown in FIG. 7, the Unit 106 pull-down menu provides the manager 60 the ability to select a Critical Items menu 124 and an Action Plan Tool menu 126. When the manager 60 selects the Critical Items menu 124, the manager is presented with the action planning tracking report 82 (alternatively referred to as the Critical Items report). Alternatively, when the manager 60 selects the Action Plan Tool menu 126, the manager 60 is presented with the action planning tool 90.

As shown in FIG. 7A, the Tools pull-down menu provides the manager 60 the ability to select a Disposition menu 125, a Response Distribution menu 127, and a Custom Comparators tool 129.

### Facility Performance at the Unit Level

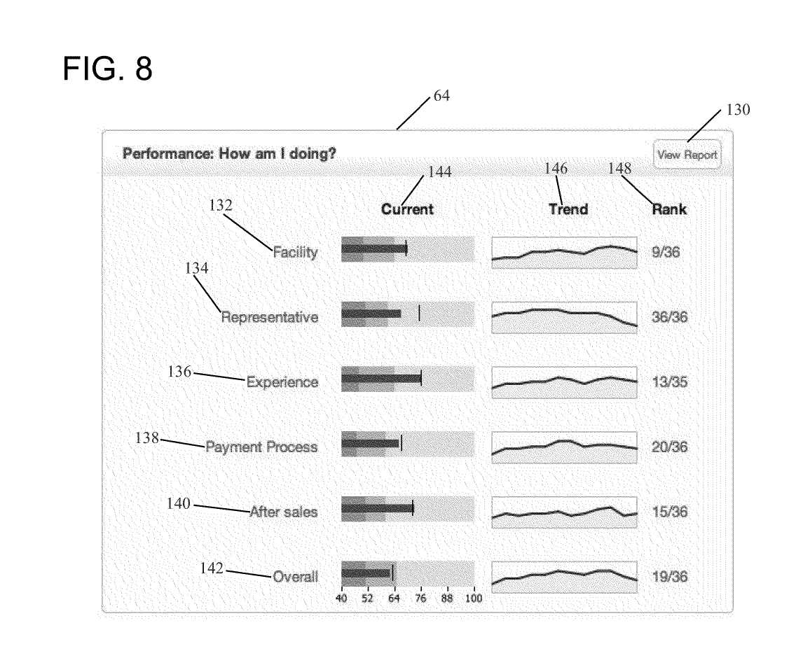

FIG. 8 through FIG. 11 describe the various interfaces, reports and tools that the manager 60 can access to determine the performance of the facility 60.

Referring now to FIG. 8, which illustrates the facility performance interface 64 located in a first quadrant of the Integrated, Interactive Display 22 shown in FIG. 3. The facility performance interface 64 provides the manager 60 with the ability to select a View Report 130 and a plurality of metrics. Upon selecting the View Report 130, the manager 60 is presented with a performance shown in FIG. 9 and described below. The facility performance interface 64 further includes a plurality of user-selectable links for the manager 60 to view performance metrics, such as a facility metric 132, a representative metric 134, an experience metric 136, a payment process metric 138, an after sales metric 140, and an OverallSATisfaction (“OSAT”) metric 142. Associated with each metric is a dashboard that includes an indication of a current performance 144, a trend 146, and a rank 148.

The dashboard displayed on the facility performance interface 64 depicts an overall performance based on an aggregate of other sub-metrics. For example, when a manager 60 selects the experience metric 136 (e.g., takes a mouse and clicks on the experience metric 136 link), a set of experience sub-metrics 150 is displayed (shown in FIG. 9). Referring now to FIG. 9, the experience sub-metrics 150 includes metrics such as an low pressure experience metric 152, a working for your best interests metric 154, a honest and trustworthy fashion metric 156, or any other metric based on the experience of a customer. The processor 12 aggregates the values of the experience sub-metrics 152-156 to provide the manager 60 with the overall experience metric 136 shown on the facility performance interface 64 of FIG. 8. In addition, each of the sub-metrics 152-156, shown in FIG. 9, further includes a corresponding dashboard providing a current performance, a trend, and a rank.

Therefore, by selecting a particular metric from the facility performance interface 64, such as 136, the manager 60 is able to “drill-down” and be provided with additional details. In this example, the experience dashboard on the performance interface 64 indicates to the manager 60 that the performance metric experience 136 for the facility 24 has a current 144 value of about 80. By selecting the experience metric 136 link, the manager 60 is able to “drill-down” to determine (see FIG. 9) that the sub-metric low pressure experience 156 has a value of about 76. The sub-metric low pressure experience 156 is reducing the overall score for experience for the facility 24. The manager 60 is able to confirm that this sub-metric has been reducing the overall experience score for the facility 24 by examining the corresponding trend and rank dashboards for the sub-metric low pressure experience 156. As shown in FIG. 9, the trend 158 for the sub-metric low pressure experience 156 has been declining and the rank 160 for the sub-metric is a nineteen out of a total number of thirty-five facilities. Thus, by “drilling-down” from the initial metric presented on the performance interface 64, a manager 60 is provided with additional detailed information that summarizes critical aspects that determine the overall performance for the facility 24. In general, each selection process herein which allows a manager or others to obtain additional information comprises a “drill-down” aspect.

Referring now to FIG. 9, it illustrates the performance report 76 for a selected facility 24. The performance report 76 can be accessed by the manager 60 selecting the performance pull-down menu 100, shown in FIG. 4, on the Interactive Display 22, or by the manager 60 selecting View Report 130 from the facility performance interface 64, shown in FIG. 8. The performance report 76 provides a plurality of performance metrics and corresponding dashboards for a current performance 162, a trend 164, and a rank 166.

The facility performance interface 64 and associated metrics and corresponding dashboards provide a manager 60 a quick, high-level view of the performance of the facility 24. The performance report 76 allows the manager 60 to review additional performance metrics not shown on the facility performance interface 64.

Referring now to FIG. 10, it illustrates the predictor model 84 for the selected facility 24. The manager 60 can access the predictor model 84 by selecting the predictor model link 112 from the performance pull-down menu 100 (shown in FIG. 4). The predictor model 84 provides a manager 60 with a plurality of questions 170, an overall experience predictor model 172, a predicted score 174, and a score 176. The questions 170, in an embodiment, may be the same questions asked by customers 38 when filling out the survey 40 after visiting the facility 24, or the questions 170 may be substantially different from the survey 40 based on the products and/or services of the facility 24. Further, the number of questions asked can be greater or fewer than the number of questions shown in the example of FIG. 10. Associated with each question 170 is the overall service experience predictor model 172, the predicted score 174 and the actual score 176.

In an embodiment, the predictor model 84 can be used by the manager 60 to prioritize particular metrics customers have deemed important to improve the performance of the facility 24. For example, as shown in FIG. 10, the overall experience predictor model 172 includes a “slider” 180 that the manager 60 can move to maximize or minimize the predicted score 174 between a value of zero to one-hundred. By moving the slider to the left, the manager 60 can minimize the predicted score 174 value (e.g., set the score to zero) or the manager 60 can move the slider 180 to the right to maximize the predicted score 174 value (e.g., set the score to 100). If the manager 60 wants to minimize the value of the customer 38 response for a particular question 170 (e.g., that relates to a particular performance metric), the manager 60 can move the slider 180 toward the left to decrease the weight of the question 170. Alternatively, if the manager 60 wants to maximize the value of the customer 38 response for a particular question 170, the manager 60 can move the slider 180 to the right to increase the predicted score of the question 170. By altering the predicted scores of the questions, a manager 60 is able to simulate future performance of the facility 24 on an overall metric (e.g., Overall Satisfaction).

For example, if customers surveys 40 have typically indicated that the facility does not provide a “product knowledge” 182, the manager 60 can increase the simulated future performance of the question 170 for “product knowledge” 182 by moving the slider 180 until the predicted score 174 is increased, for example, to a value of 80. Alternatively, if the majority of customers 38 find the employees 62 and team at the facility 24 to be honest, then the manager 60 can moved the slider 180 until the predicted score 174 is decreased, for example, to a value of 25 to minimize the question 170 for “honesty” 184. Thus, the predictor model 84 provides a method for the manager 60 to simulate the future performance metrics in particular selected areas for the facility 24.

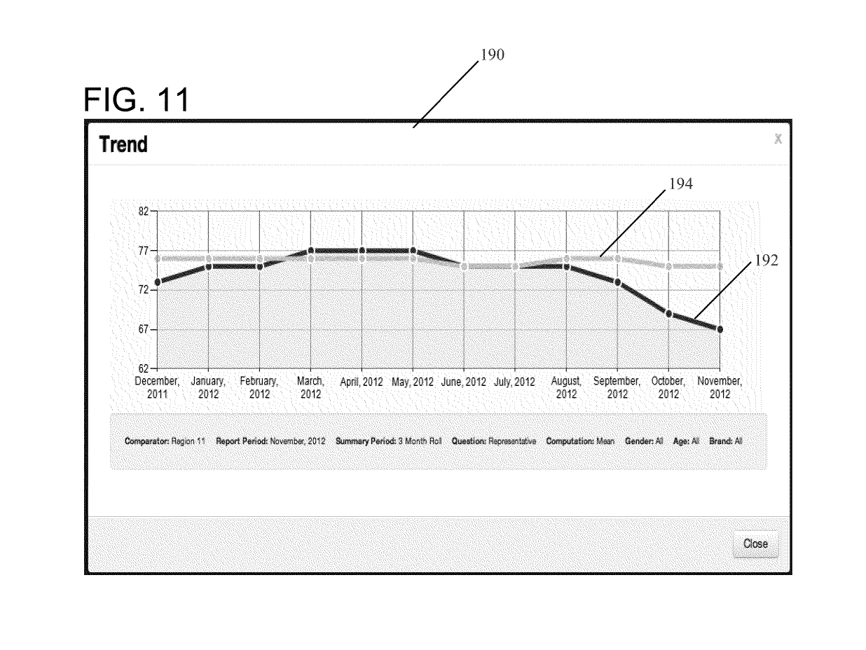

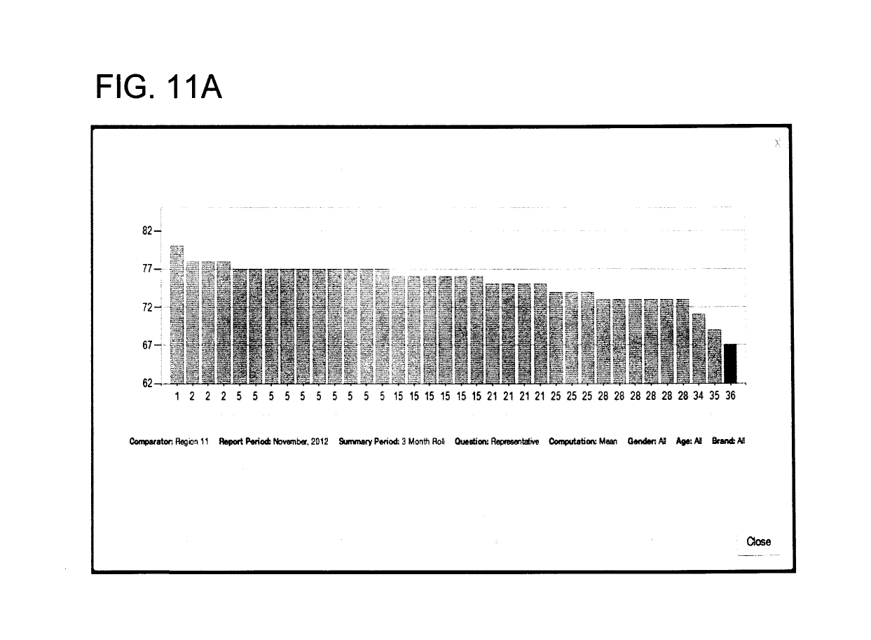

Referring now to FIG. 11, it provides a graphical display 190 of an exemplary trend line 192 illustrating the ranking of the facility 24 over a period of time compared to a selected benchmark 194. As described above, the facility performance interface 64 provides for each performance metric a corresponding trend 146 (see FIG. 8). If the manager 60 wants additional detailed information regarding the performance of the facility 24 over a period of time (e.g., over a year time frame), the manager 60 can select trend 146 on the graphical dashboard of the facility performance interface 64.

The graphical display 190 provides to the manager 60 monthly performance values 196. Therefore, the manager 60, for example, can determine the performance of the facility 24 in any (e.g., an experience metric 136) area during the summer months or any selected timeframe. In addition, the manager 60 can compare the trend 192 for any metric (e.g., an experience metric 136), with a selected benchmark 194 for the metric. Comparison with the selected benchmark 194 provides additional information to the manager 60 as to whether the facility 24 is meeting its performance goals.

For instance, if the trend line 192 is consistently below the benchmark 194 (e.g., over a period of a few months), the manager 60 is provided information that the facility 24 for example, is not meeting its performance goals based on the benchmark 194 and the facility is under-performing for the selected metric. Thus, the graphical display 190 of the trend line 192 compared to the benchmark 914 provides more information than a chart merely showing an increase or a decrease in a performance metric.

FIG. 11A illustrates an exemplary histogram illustrating the facility rank among peers within the given timeframe which is accessible by selecting the “rank” shown in the facility performance interface 166 shown in FIG. 9.

### Employee Performance at the Unit Level

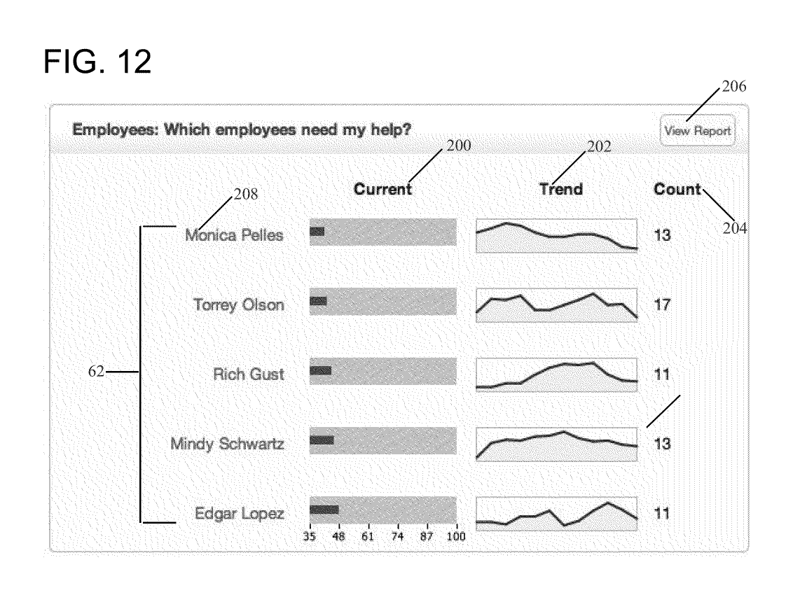

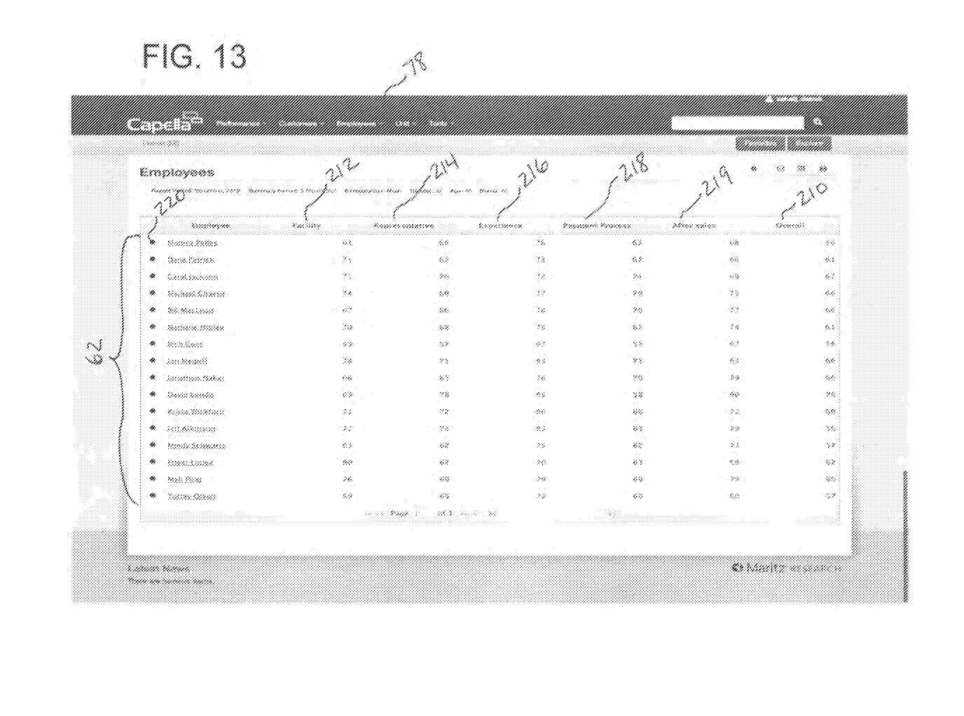

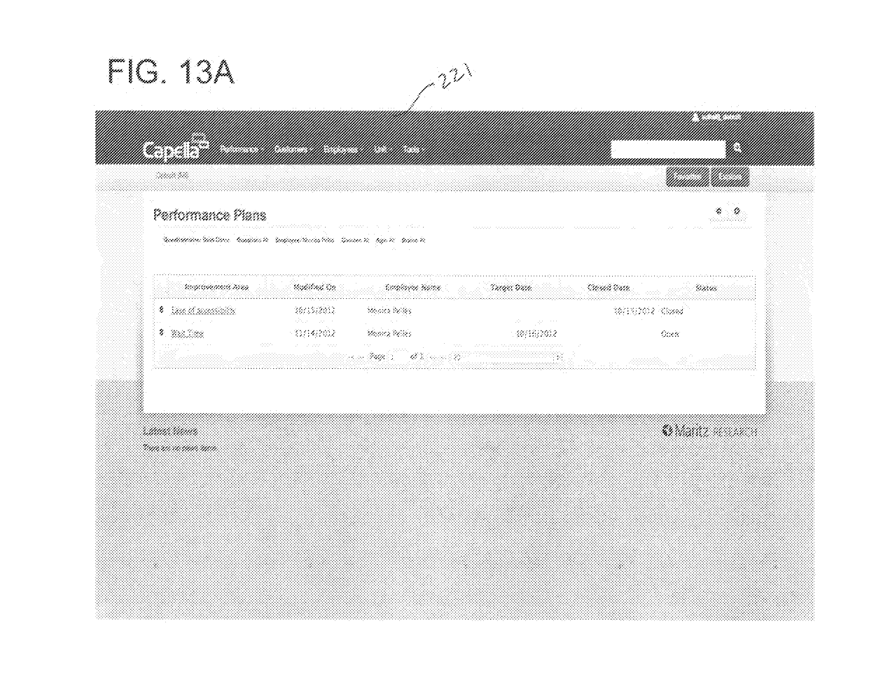

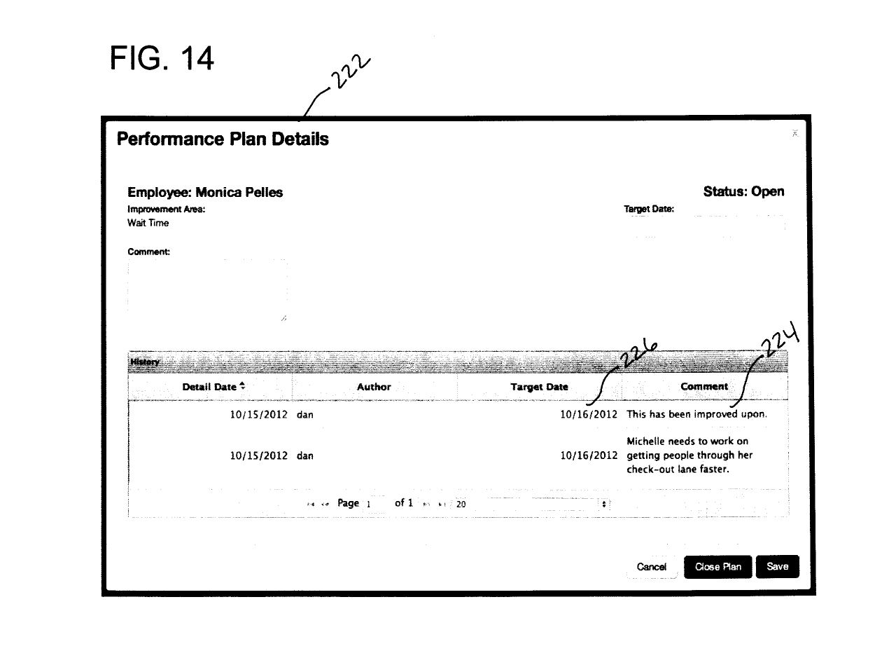

FIG. 12, FIG. 13, and FIG. 14 describe the various interfaces, reports, and tools that the manager 60 can access to determine the performance of a team of employees 62 reporting to him/her the facility 24.

Referring now to FIG. 12, it illustrates the employee evaluation interface 66 located in a second quadrant of the Integrated, Interactive display of FIG. 3 The employee evaluation interface 66 provides the manager 60 a top level graphical view of the performance of a select group of employees 62. Similar to the facility performance interface 64, the employee evaluation interface 66 includes a plurality of user-selectable links 208 (e.g., take a mouse and clicks on the link) for the manager 60 to view the performance of a plurality of employees 62. Associated with each employee 62 is a dashboard that includes an indication of a current 200 employee performance, an employee's performance trend 202, and a count 204 (e.g., rank in comparison with all the other employees 62 at the facility 24). The employee evaluation interface 66 and the corresponding dashboards (e.g., current performance 200, trend 202 and count 204) provide a manager 60 a quick, high-level view of the performance of a particular employee 62.

For additional information regarding a particular employee's 62 performance, the manager 60 can select the link 208 associated with the employee's name. Upon selecting the link, the manager 60 is presented with an employee performance report 78 (shown in FIG. 13) that identifies a plurality of performance metrics for the selected employee 62. Furthermore, the manager 60 is also able to review the employee performance report 78 by selecting a “View Report” 206 link on the employee evaluation interface 66. The manager 60 can access additional employee performance information through the dashboard and “drill-down” for additional details regarding the employee's 62 performance. For instance, the dashboard provides the current 200 performance of a particular employee 62 in graphical form. The manager 60 is able to immediately review, in one embodiment, a set of employees 62 that are in need of assistance in improving their performance. In addition, the manager 60 can garner additional details, regarding an employee's 62 performance, by selecting trend 202 from the employee evaluation interface 66 dashboard. By selecting trend 202, the manager 60 is provided with a graph (similar to performance trend shown in FIG. 11) that provides the employee's 62 performance compared to a performance goal over a period of time.

Referring now to FIG. 13, it illustrates an exemplary employee summary report 78. A manager 60 can access the employee summary report 78 by selecting the Employees 120 from the Employees pull-down menu 104 shown in FIG. 6. Alternatively, the manager 60 can select the “View Report” 206 link on the employee evaluation interface 66. The employee summary report 78 provides a plurality of metrics that evaluate the employee 62. In one embodiment, the metrics include an OverallSATisfaction (“OSAT”) metric 210, a facility metric 212, a representative metric 214, an experience metric 216, a payment process metric 218, and an after sales metric 219. Alternatively, a manager 60, in another embodiment, could select a different set of metrics to be used to evaluate the employee 62 based on the needs of the facility 24. For example, if the facility 24 needed to improve a customer's belief that they are more “likely to return”, the manager 60 could determine that the employees 62 need to increase their performance so that customers 38 upon completing a commercial transaction either believe or have a perception that they are more than “likely to return” to the facility 24 for their next transaction. Thus, the “likely to return” could be added as a metric to evaluate employee performance.

FIG. 13A illustrates an exemplary performance plans report 221 accessible by the user by selecting “performance plans” 122 from the Employees pull-down menu 104 shown in FIG. 6, or by selecting the “plan” icon 220 next to an employee name from the Employees report shown in FIG. 13.

The employee summary report 78 further provides an icon 220, which the manager 60 can select to display an employee's performance plans 222. Referring now to FIG. 14, it illustrates the employee performance plan 222. The manager 60 can also access the employee performance plan 222 by selecting the Employees summary 120 link from the Employees 104 pull-down menu shown in FIG. 6, and then selecting plan 120.

The employee performance plan 222 provides specific areas for the manager 60 to identify as performance improvement areas for the employee 62. For example, in one embodiment, the employee performance plan 222 includes action steps 224 and a completion date 226 for the action steps 224.

### Customer Management at the Unit Level

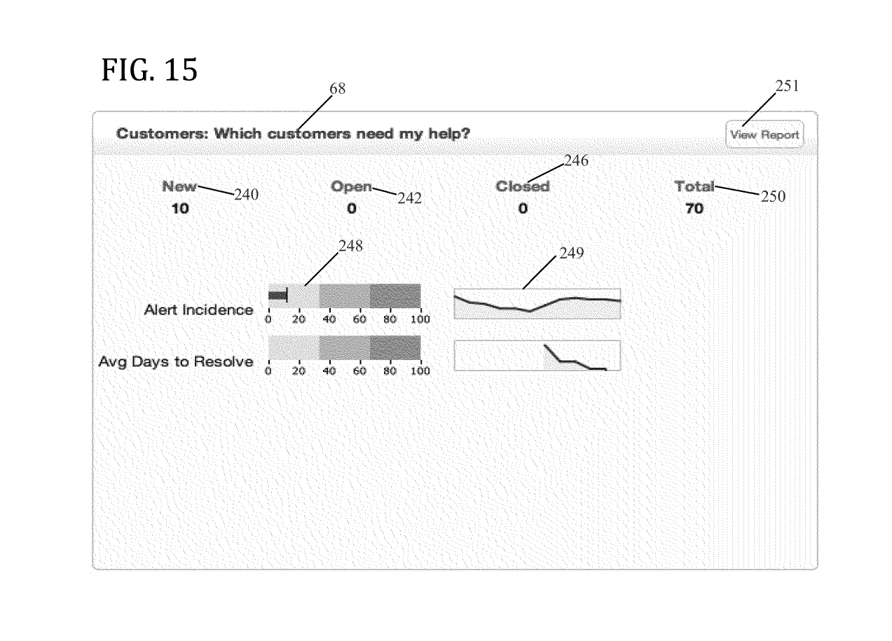

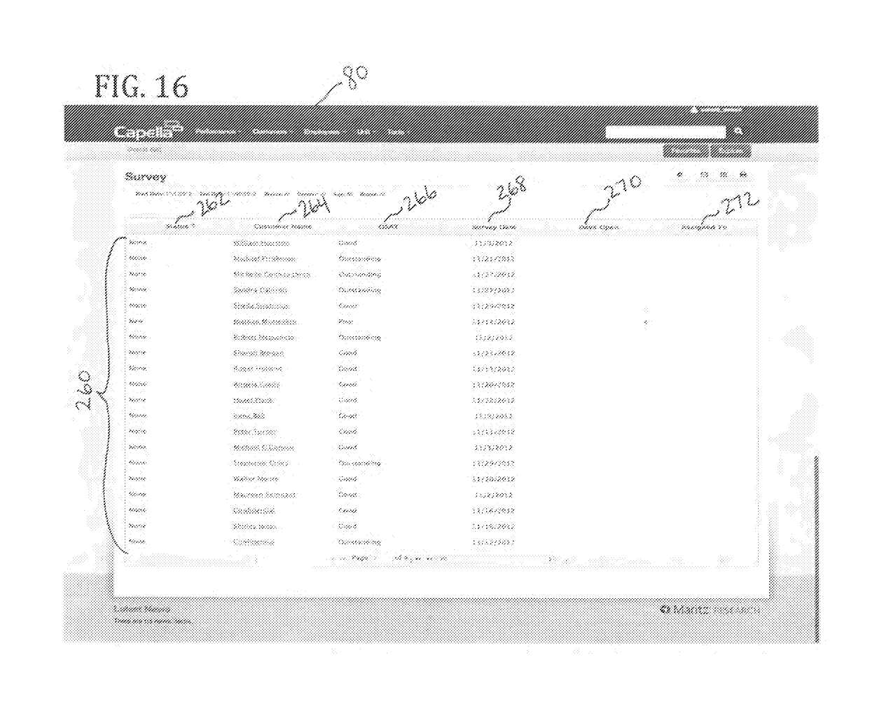

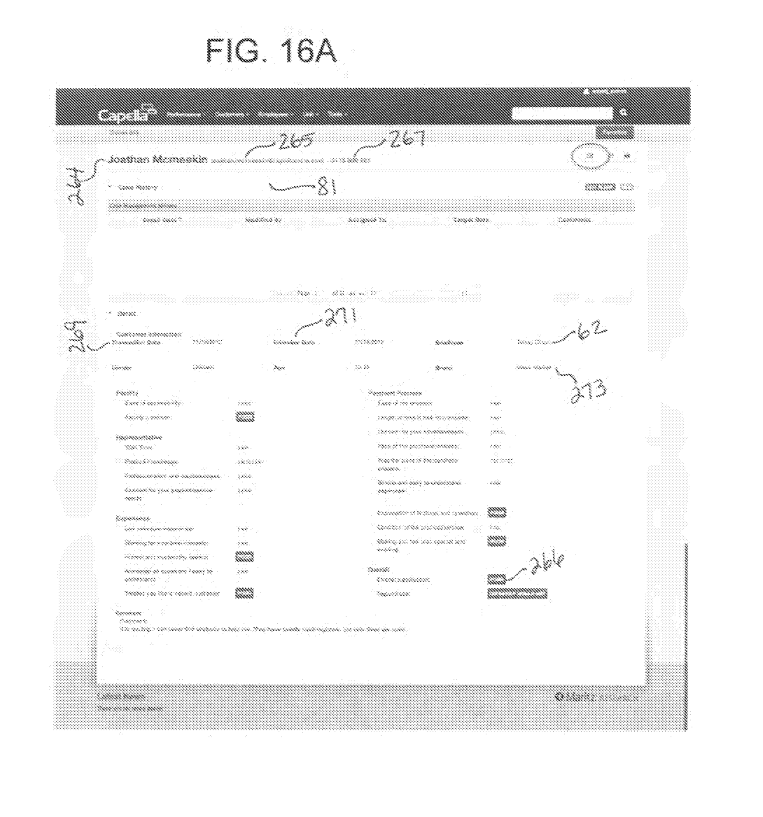

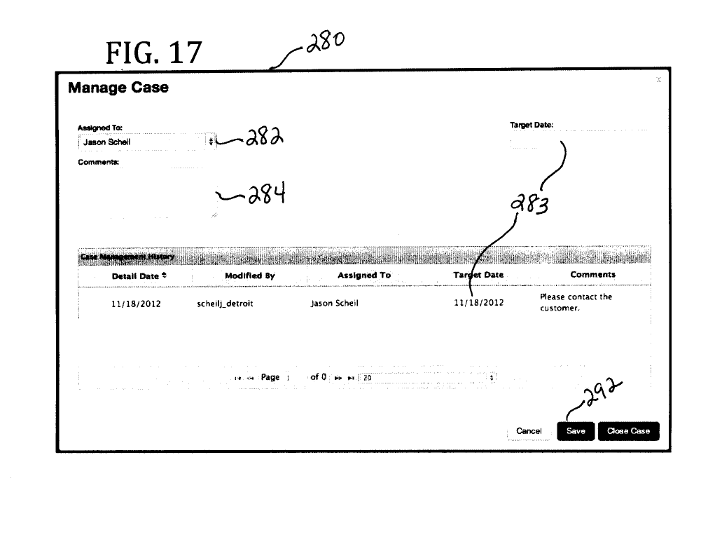

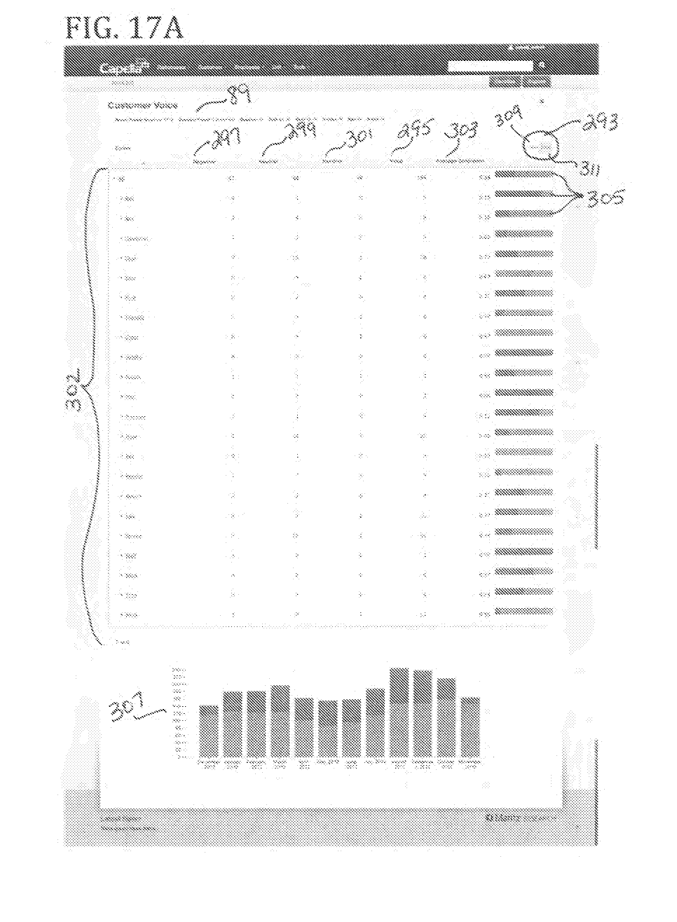

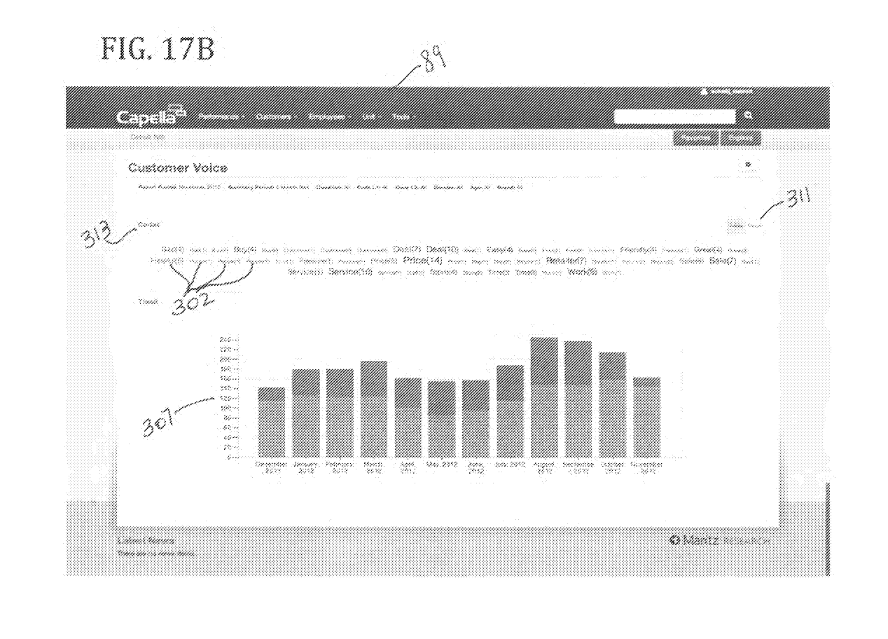

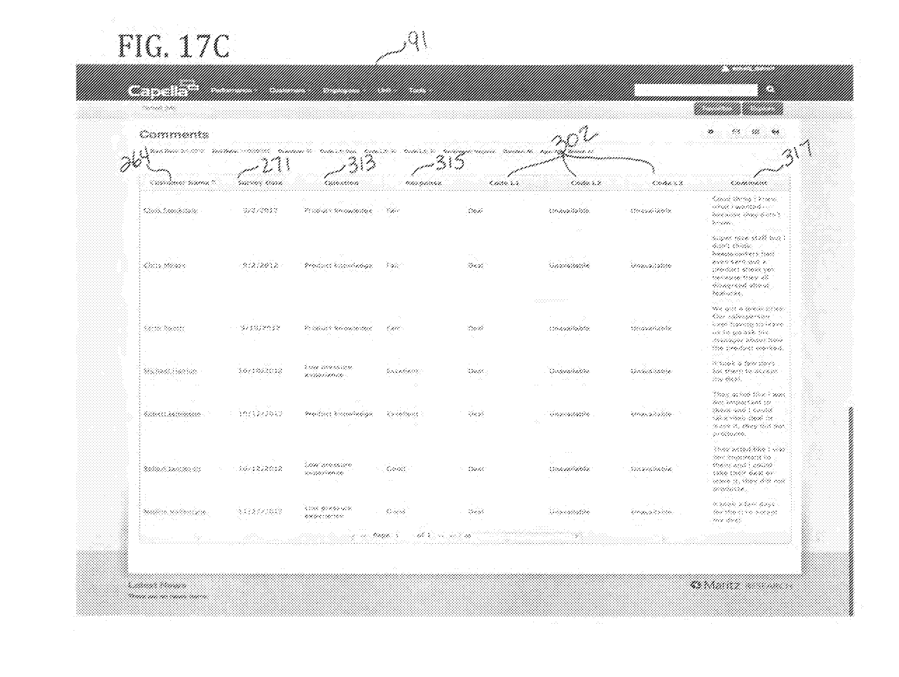

FIG. 15, FIG. 16, and FIG. 17 describe the various interfaces, reports, and tools that a manager 60 can access to manage customer alert data regarding commercial transactions at the facility 24.

Referring now to FIG. 15, it illustrates the customer management interface 68 located in a third quadrant of the Integrated, Interactive Display 22. The customer management interface 68 graphically shows a dashboard displaying customer hot alert data triggered from customer feedback 36. The critical customer issues are classified as new issues 240, open issues 242, and closed issues 246. Similar to the facility performance interface 64 and the employee evaluation interface 66, the customer management interface 68 includes a dashboard having a current 248 status of customer issues and a count 250 of the number customer issues for the facility 24. In addition, the customer management interface 68 has a “View Report” link 251 that allows the manager 60 to review a survey list 80, shown in FIG. 16. The manager 60 can select the survey list 80 to only provide him/her with a selected type of customer issue, such as a list of only new issues 240, only open issues 242, or only closed issues 246.

Referring now to FIG. 16, it illustrates the survey list 80 that is accessible to the manager 60 by selecting the Surveys menu 116 from the Customers 102 pull-down menu shown in FIG. 5. Alternatively the survey list 80 is available to the manger by from the customer management interface 68, previously discussed. The survey list 80 provides the manager 60 with a list of all completed surveys and/or customer issues 260. The survey list 80 displays to the manager 60 a status 262, a customer name 264, an OverallSATsifaction (“OSAT”) 266, a survey date 268, the number of days open 270, and identifies which employee 62 each particular customer issue 260 has been assigned to 272. The survey date 268 provides the date the customer 38 completed the survey 40. By selecting the customer name 264, a manager 60 is provided a Survey Detail report 81, which contains a link to the case management portal 280 that provides a tool to respond/manage a particular selected customer issue 260.

Referring now to FIG. 16A, it illustrates the Survey Detail report 81. The Survey Detail report 81 provides the manager 60 with customer information 38 such as a customer's name 264, a customer's an email address 265, a customer's phone number 267, a transaction date 269, an interview date 271, a brand 273, the OSAT rating 266, and the employee 62 assigned to the particular customer issue 260.

Referring now to FIG. 17, it illustrates the case portal 280 from which the manager 60 can assign a particular customer issue 260 to an employee 62 to process, and the employee 62 can update the status 262 of the customer issue 260. The manager 60 can assign the employee 62 to the customer issue 260 or change the employee 62 assigned to the customer issue 260 by using the assign to pull-down menu 282. In one embodiment, the type of action is dictated by the manager, who provides direction(s) in the Comments 284 section. Additional types of action can be included, such as texting the customer, sending a SMS message, sending a letter, sending a fax, and the like. The manager 60 can also insert a target date 283 for when the customer issue 260 needs to be resolved. In addition, the case management portal 280 has an area for the employee 62 to place comments 290 such as additional facts provided by the customer regarding the issue 260 or the steps the employee 62 has taken to resolve the customer issue 260. After updating the case management portal 280, the manager 60 or employee 62 assigned to the customer issue 260 can save 292 their work.

FIG. 17A illustrates an exemplary Customer Voice report 89 accessible by the user selecting of “Customer Voice” 118 from the Customers 102 menu in FIG. 5. The report has a default Customer Voice view menu 293 allowing a user to choose how to view the report, including “Table” mode 309 and “Cloud” mode 311. In “Table” mode 309, the report displays coded comments 302 from customer feedback 36. The report shows how many times a given coded comment 302 was included 295, and the number of times the coded comment 302 was included in negative feedback 297, neutral feedback 299, and positive feedback 301. The report also calculates average sentiment for each code 303. Additionally, each code has a bar graphic 305 that visually displays the relationship between negative, neutral, and positive feedback. The report includes a bar graph 307 indicating the negative, neutral, and positive feedback from customers as a function of time.

FIG. 17B illustrates an alternate view of the Customer Voice report 89 accessible by the user selecting of “Cloud” 311 from the default Customer Voice view menu 293 in FIG. 17A. The “Cloud” mode 311 of the report includes the bar graph 307 as well as a “cloud” 313 of coded comments 302. The number depicted next to the coded comments 302 is a tally of the code frequency. The font size of the code represents a relative impact of the code 302 for a critical area. In an embodiment, the coded comments may also be color coded. For instance, a green color may indicate a positive feedback, a black color may indicate a neutral feedback, and red color may indicate a negative feedback.

FIG. 17C illustrates an exemplary Comments report 91 accessible by the user selecting of “Comments” 119 from the Customers menu 102 in FIG. 5. The Comments report 91 presents a table for displaying information about customer feedback 36. The Comments report 91 table displays the customer name 264, the survey date 271, the question topic 313, the response rating 315, coded comments 302, and open-ended comments 317.

### Priority List at the Unit Level

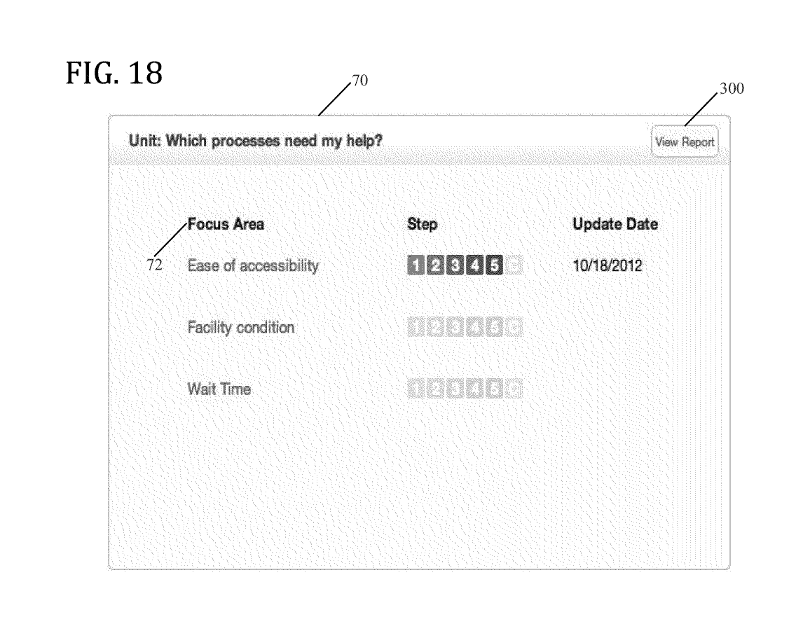

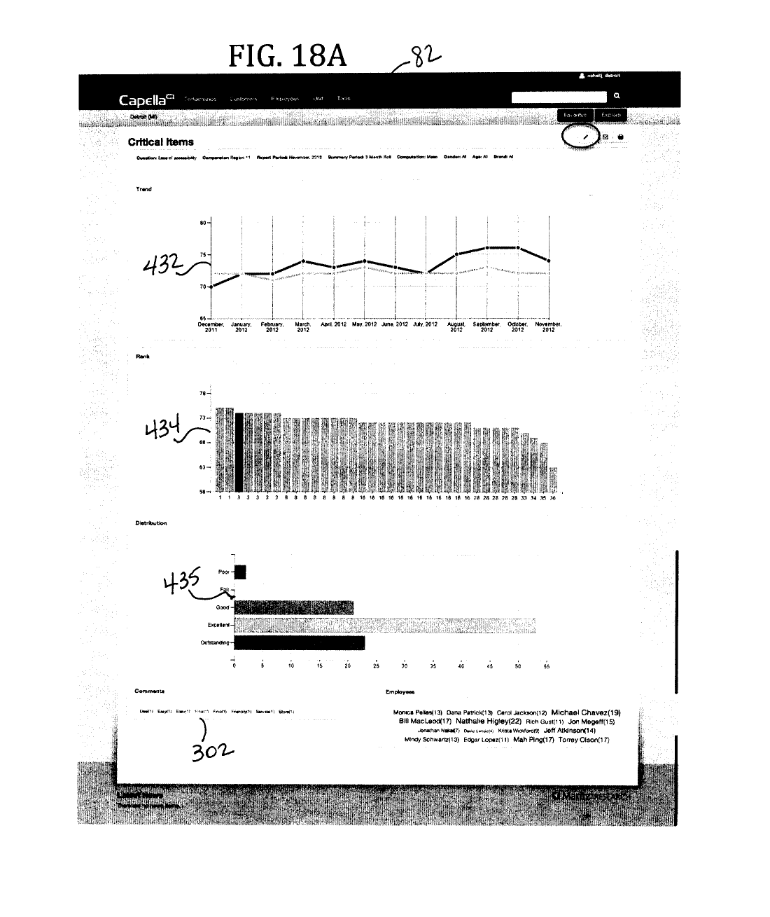

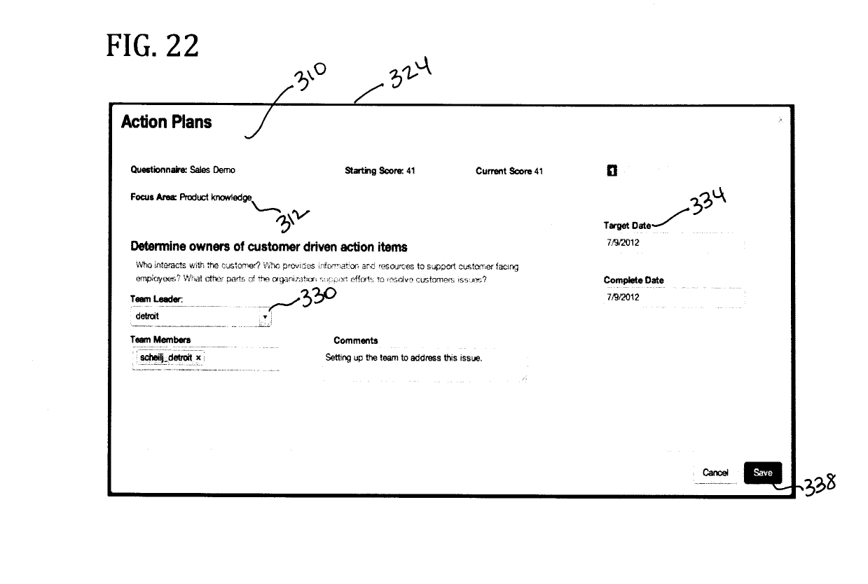

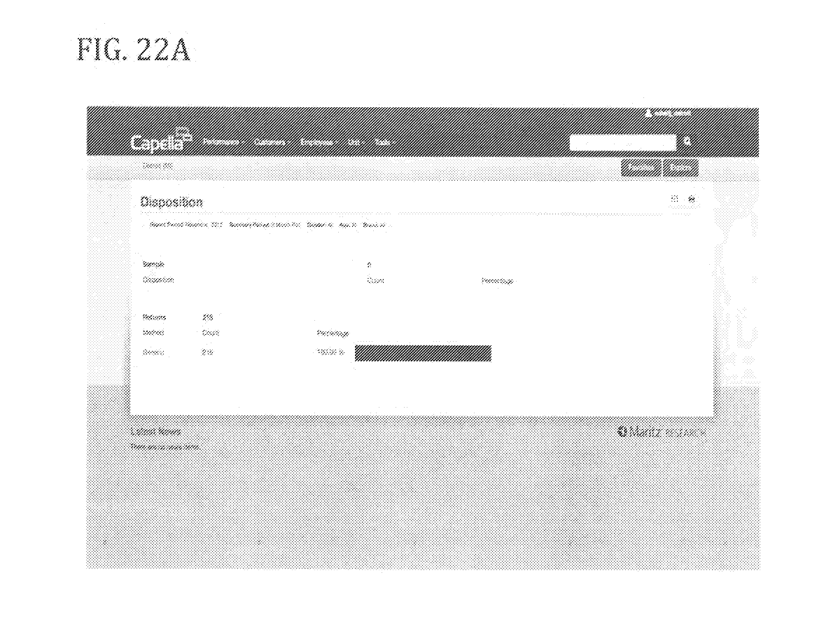

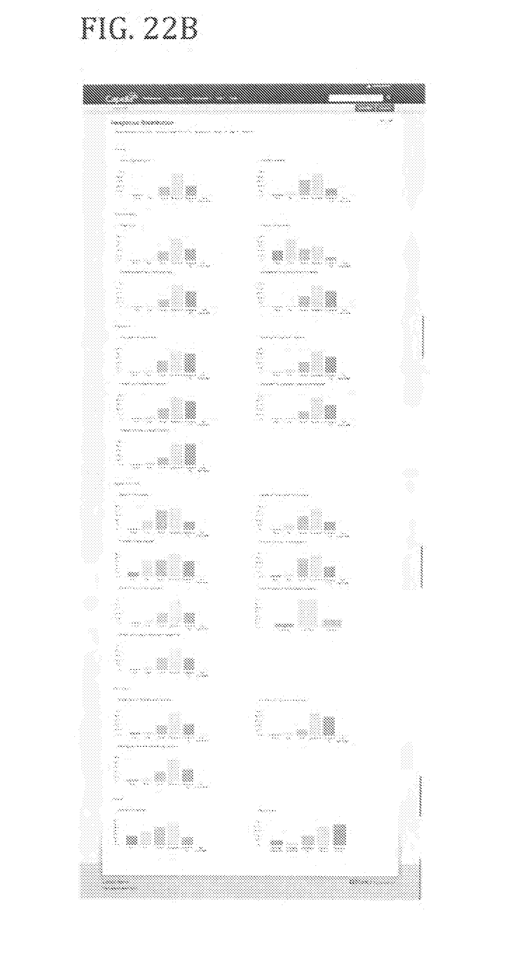

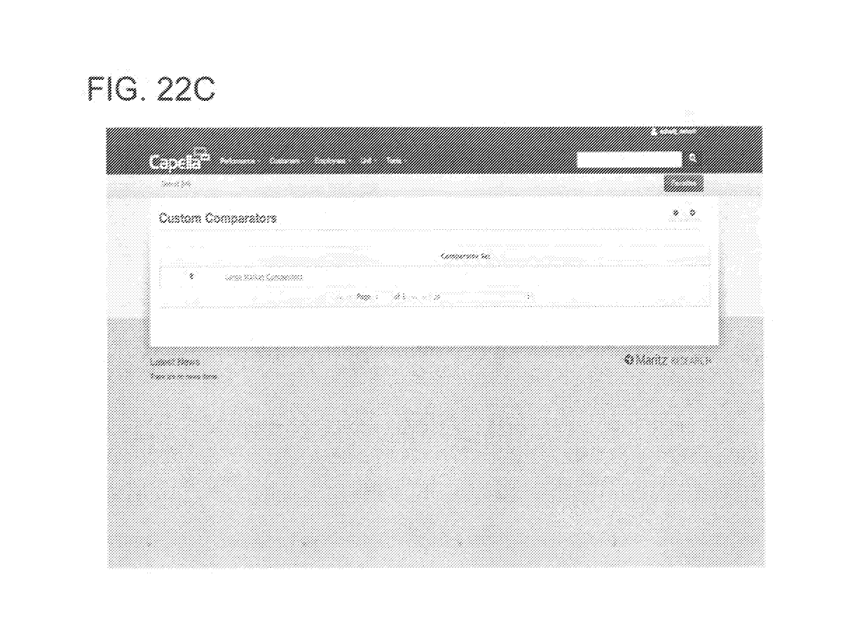

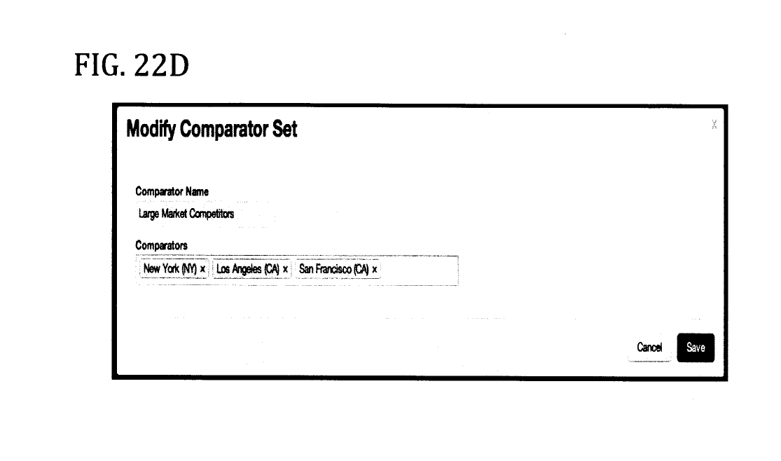

FIG. 18 though FIG. 22, describe the various interfaces, reports, and tools that a manager 60 can access to prioritize workflow at the facility 24.

Referring now to FIG. 18, it illustrates the priority list interface 70 located in one embodiment in a fourth quadrant of the Integrated, Interactive Display 22. The priority list interface 70 provides the manager 60 a list of links 72 where each link 72 corresponds to a particular performance metric. In one embodiment, the links 72 can include performance metrics such as: “made you feel special”, treated as a valued customer”, “honest and trustworthy”, fairness of amount paid”, “explanation of paperwork”, and “explanation of features”. The manager 60 may select other performance metrics depending upon the performance of the facility 24. For example, the manager 60 could include “ease of process”, “length of time to pay”, “professionalism”, “low pressure”, and the like.

Upon selecting one of the links 72 corresponding to a particular performance metric, the manager 60 is provided with the Critical Items report 82 (shown in FIG. 18A). The manager 60 can also access the Critical Items report 82 by selecting the Unit menu 124 from the Unit 106 pull-down menu shown in FIG. 7.

Referring now to FIG. 18A, the Critical Items report 82 includes a trend chart 432, a graph indicating the rank 434 of the facility compared to other facilities, a plurality of coded comments 302, and a list of employees 62.

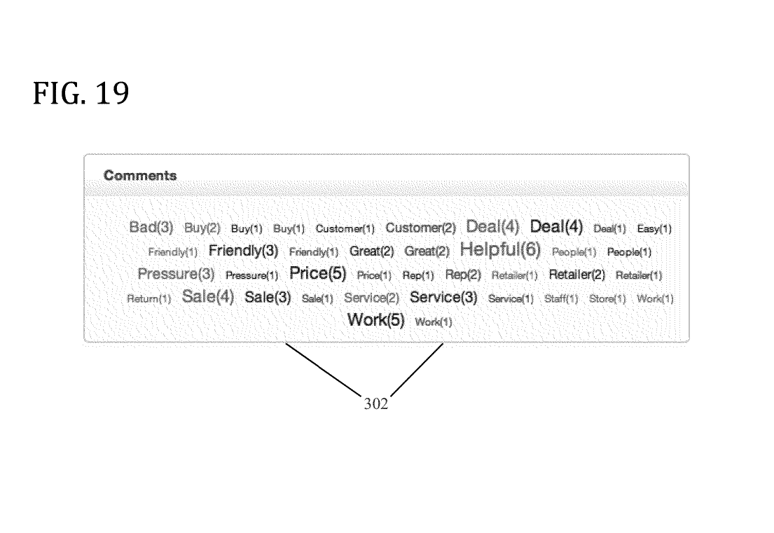

Referring now to FIG. 19, that illustrates an example of the plurality of coded comments 302. The plurality of coded comments 302 are derived from customer feedback 36, which includes customer open-ended feedback 36. The coded comments 302 provide the manager 60 with a count of the most common topics provided by the customer 38 in their feedback 36. The number depicted next to the coded comments 302 is a tally of the code frequency. The font size of the code represents a relative impact of the code 302 for a critical area. In an embodiment, the coded comments may also be color coded. For instance, a green color may indicate a positive feedback, a black color may indicate a neutral feedback, and red color may indicate a negative feedback. The number of coded comments 302 displayed is dictated by the codes assigned the particular performance metric by the text analytic engine and displayed on the Critical Items report 82. For example, “ease of accessibility” 303 (shown in FIG. 18) may list coded comments 302 such as buy, easy, product, return, service, time, and work.

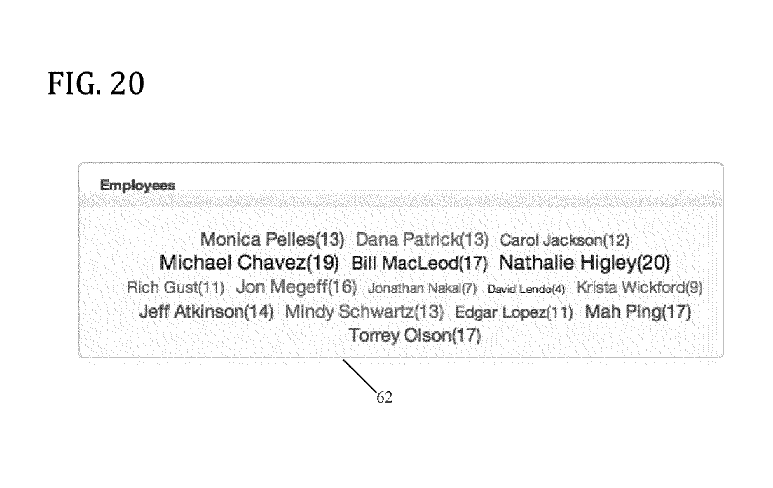

In addition, the Critical Items report 82, shown in FIG. 20, includes a plurality of employees 62 and their relative impact on the critical item area, as shown in FIG. 20. The performance of an employee 62 is depicted by the color the employee's name displayed on the Critical Items report 82 and the size of the font the employee's name depicts relative impact of the employee 62 for the given critical item presented on the report 82. For example, a red color indicates that the employee 62 is performing poorly. A green color indicates that the employee 62 is performing well, and a black color indicates that the employee 62 has an “average” performance. The number shown next to the employee's 62 name is a total number of customer feedback surveys 36 completed by customers 38 for the employee 62 indicated. The larger the font size displaying an employee's 62 name indicates the relative impact of that employee 62 on the overall facility 24 based on the amount of customer feedback 36 for that employee 62. Therefore, if the employee's 62 name is presented in a twelve point font, it indicates to the manager 60 that the employee 62 has more customer feedback 260 than an employee 62 whose name appears in an eight point font. By graphically displaying the names of the employees 62 in this manner, a manager 60 is quickly able to identify which employees 62 (e.g., those in large red fonts) need assistance, and those employees 62 that are performing well (e.g., those in large green fonts). Furthermore, by selecting on the employee's name, the manager 60 is provided a survey list 80 (shown in FIG. 16) listing all the names of the customers 38 and their associated customer issues 260.

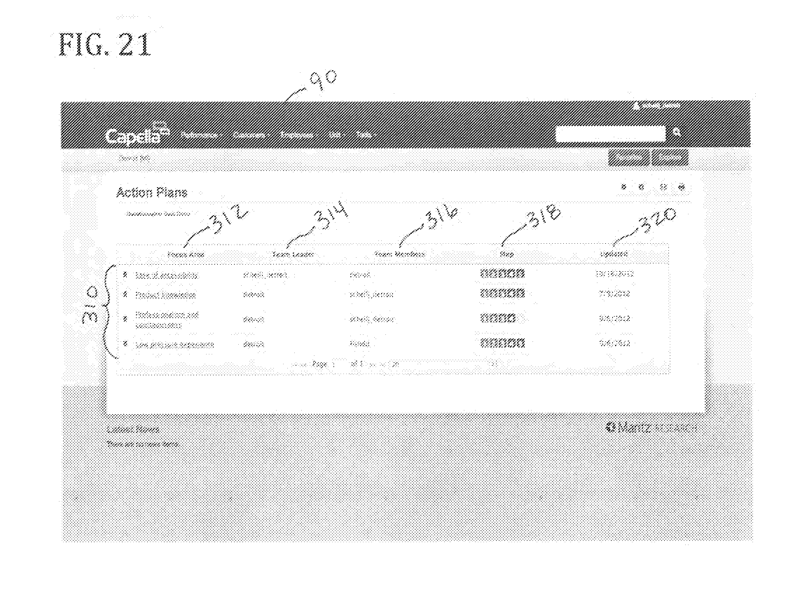

FIG. 21 illustrates the Action Plans report 90 provided to the manager 60 upon his/her selecting Action Plans 26 from the Unit pull-down menu 106 shown in FIG. 7, or by the manager 60 selecting the “View Report” 300 from the priority list interface 70 shown in FIG. 18. The Action Plans report 90 provides the manager 60 with a list of active action plans 310 that require the manager's 60 attention. Associated with each action plan 310 is a description of a focus area 312, a leader name 314, a team members list 316, a current step 318, and a last update 320. By using the action planning tool 90, a manager can create an action plan 322. In an embodiment, the action plan 322 includes a plurality of steps, for example: 1) “Do we know who is responsible for this area?”; 2) “Do we have sufficient data to identify the root cause?”; 3) “Do we know what systems, people, and processes impact this root cause?”; 4) “What specific actions will you take to address this root cause?”, and 5) “Have your changes resulted in the desired outcomes?”. The current step 318 displays to the manager at what step in the process the employee 62 has gotten to resolve the customer issue 270.

Referring now to FIG. 22, it illustrates an example of the manager 60 selecting an exemplary Action Plan 322 with a focus area 312 titled “product knowledge” and opening the unit action plan tool 324. As shown in FIG. 22, the unit action plan tool 324 allows the manager 60 to select a team leader 330 and select other employees 62 to be members of an improvement team 332. The Manager 60 also can enter a target completion date 334 and then select save 338. When the project is completed (e.g., the customer issue 270 is resolved), the team leader 330 can enter the completion date 336 and select save 338. Thus, by using the unit action planning tool 312 from the priority list interface 70, the manager 60 or a team leader 330 can put together a team to resolve customer issues 270.

### Tools at the Unit Level

FIG. 22A through FIG. 22D illustrate the various tools that can be accessed via the “Tools” menu in FIG. 7A.

Referring now to FIG. 22A, it illustrates the “Disposition” tool that can be accessed through the “Tools” menu in FIG. 7A. The “Disposition” tool displays the percentage of user surveys that have been disposed of for a timeframe.

Referring now to FIG. 22B, it illustrates the “Response Distribution” tool that can be accessed through the “Tools” menu in FIG. 7A. The “Response Distribution” tool displays a plurality of bar graphs for the metrics that are being measured by the system. The bar graphs give a graphical representation of the percentage of customer ratings for each level of the metric.

Referring now to FIG. 22C, it illustrates the “Custom Comparators” tool that can be accessed through the “Tools” menu in FIG. 7A. The “Custom Comparators” tool allows a user to compare a unit against a custom list of units in other locations.

Referring now to FIG. 22D, it illustrates the “Modify Comparator Set” tool which can be accessed by selecting the name of a Comparator Set in FIG. 22C. The “Modify Comparator Set” tool allows for the adding or removing of markets from the comparator.

### Regional/National—Above the Unit Level

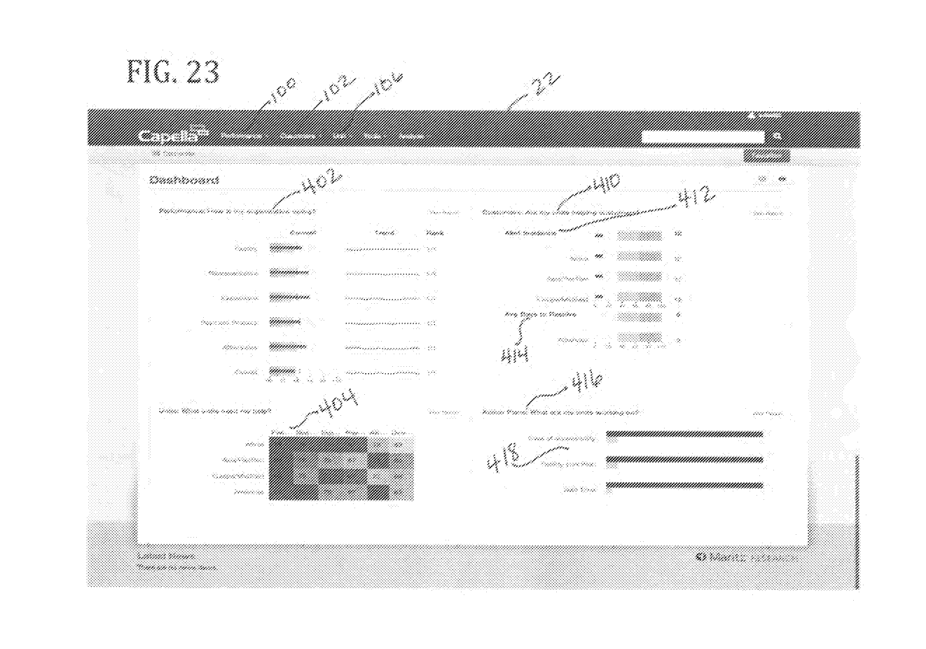

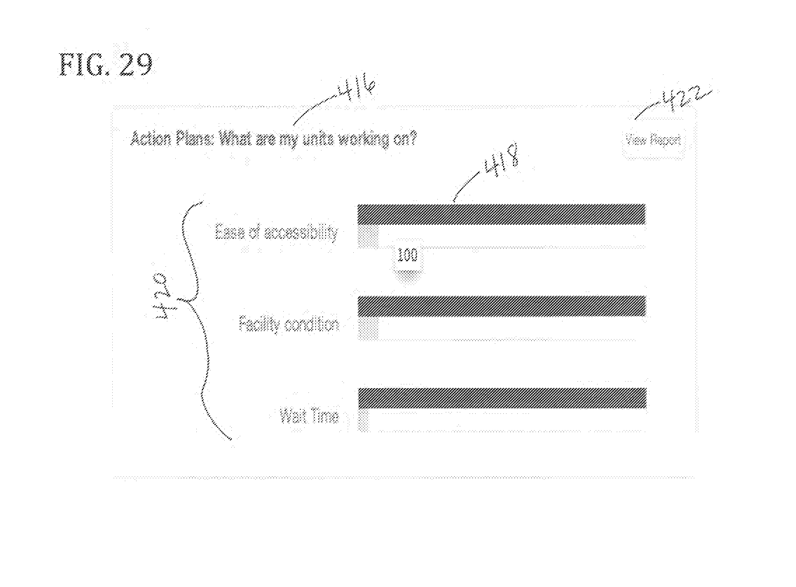

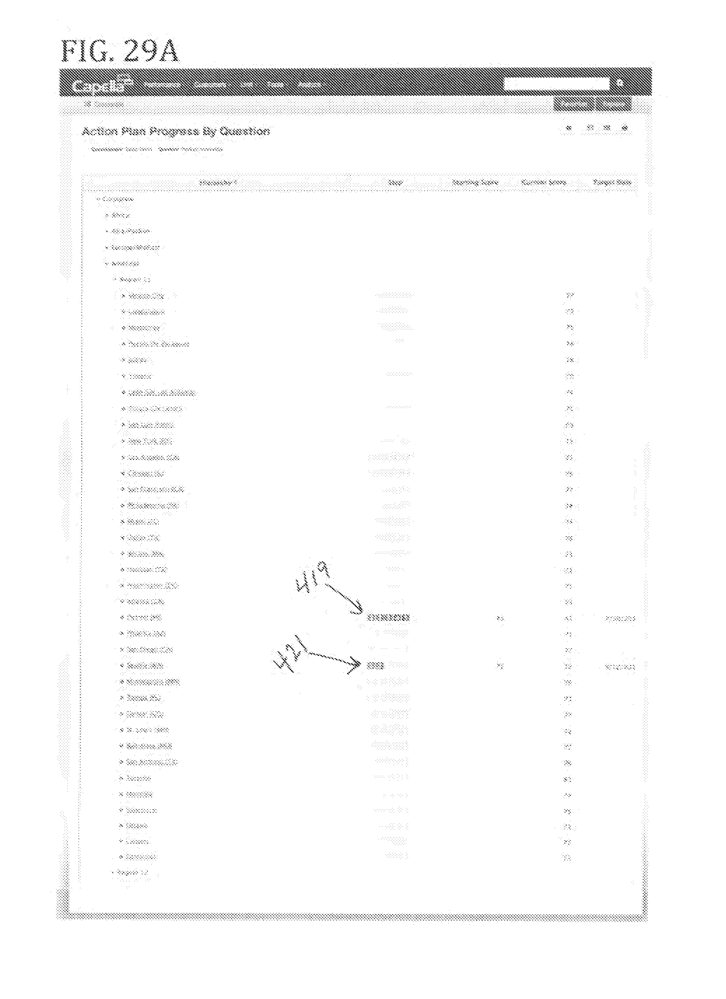

FIG. 23 though FIG. 29 illustrate the various interfaces, reports, and tools that a regional level manager can access via the integrated, interactive display 22 acting as a portal to system 10 to determine the performance of a plurality of stores in a region.

Referring now to FIG. 23, it illustrates a plurality of web-enabled interfaces that are organized in four quadrants on the integrated, interactive display 22 for a regional level manager to compare how the different facilities 24 in a region are performing, determine which facilities 24 in the region need assistance, determine which facilities 24 in the region are working on their action plans, and determine which specific faculties 24 need assistance in resolving customer issues. The integrated, interactive display 22 provides for the regional manager a regional performance interface 402, a unit evaluation interface 404, a unit management interface 410, and a regional priority list interface 416.

The regional performance interface 402 provides the regional level manager a dashboard displaying performance metrics for a region. The unit evaluation interface 404 provides the regional level manager a “heat map” 406 of a plurality of facilities 24 in a region and a plurality of metrics 408 associated with each facility 24 for the regional level manager to quickly compare how each facility 24 is performing with respect to the other facilities 24 across particular metrics 408. The unit management interface 410 provides the regional level manager a graphical dashboard that displays a list of facilities 24 that require assistance, a hot alert incidence 412, and the average number of days 414 these facilities 24 are taking to resolve customer issues 270. The regional priority list interface 416 provides to the regional level manager a graphical dashboard 418 that provides a set of performance metrics 420 that the plurality of facilities 24 in the region are resolving.

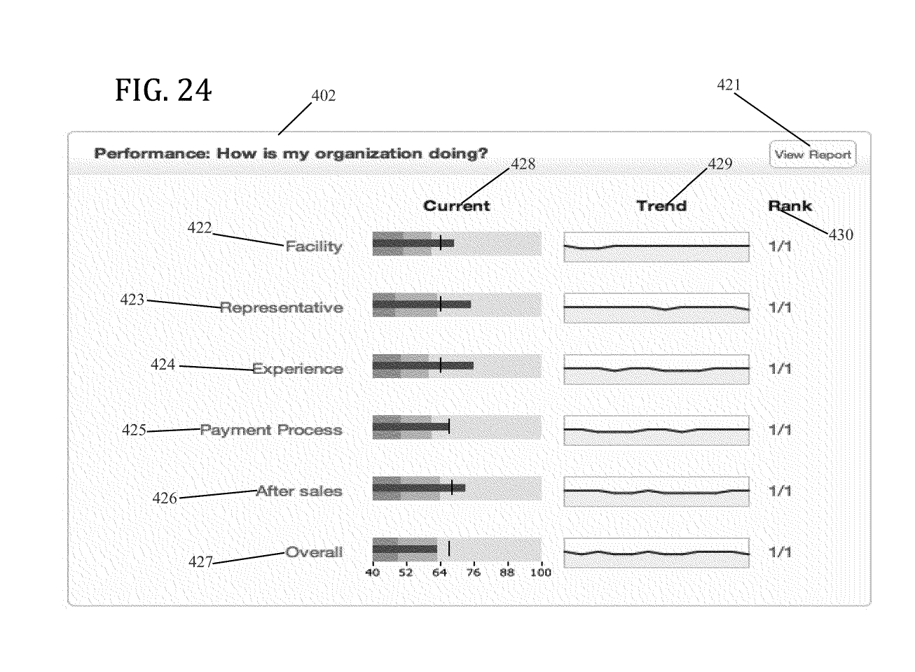

Referring now to FIG. 24, it illustrates the regional performance interface 402 located in a first quadrant of the integrated, interactive display 22 (shown in FIG. 23). The regional performance interface 402 provides performance information for a number of facilities in a region to the regional level manager similar to the performance information provided to the unit level manager 60 for a single facility 24 on the facility performance interface 64, shown in FIG. 8. Therefore, the regional performance interface 402 provides the regional manager with the ability to select a View Report 421, and further includes a plurality of user-selectable links for the regional manager to view performance metrics for the region, such as a facility metric 422, a representative metric 423, an experience metric 424, a payment process metric 425, a after sales metric 426, and an OverallSATisfaction (“OSAT”) metric 427. Associated with each metric is a dashboard that includes an indication of a current performance 428, a trend 429, and a rank 430 or the region in comparison with other regions. Thus, the regional performance interface 402 provides to a regional level manager a quick indication of the performance of the region based on a plurality of performance metrics.

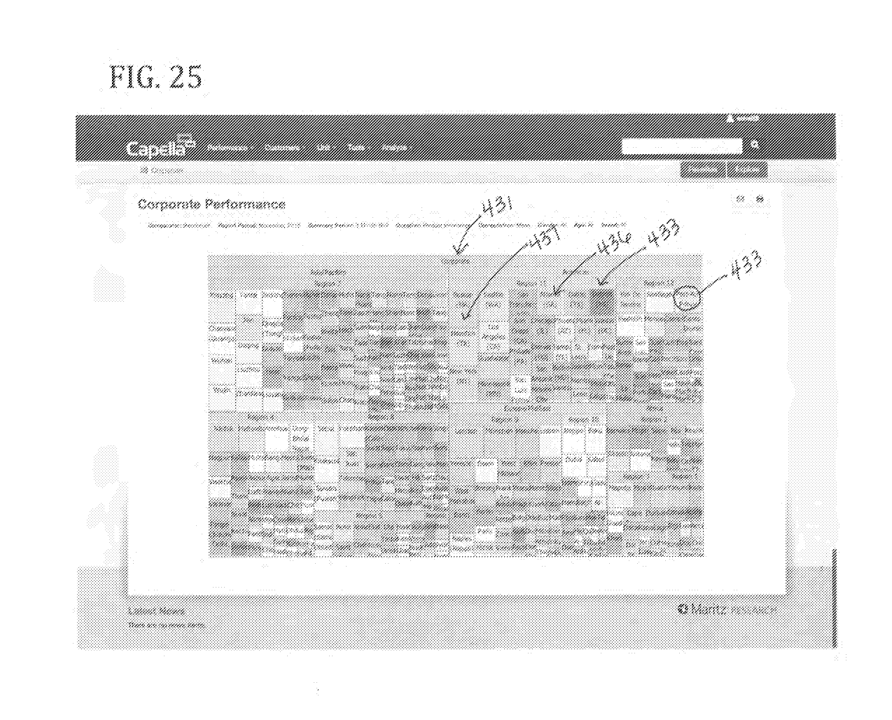

Referring now to FIG. 25, it illustrates a “treemap” 431 that provides the regional manager a relative performance of a plurality of facilities 24 located in multiple regions 433 wherein the relative performance of each facility is indicated by the size and shading of their respective cell 434. The treemap 431 can be accessed by the regional manager by selecting a region performance menu from the performance pull-down menu 100 and then select the treemap link. In addition, the treemap 431 can be accessed by the regional manager by selecting a particular link (e.g., facility 422, representative 423, experience 424 and the like) from the regional performance interface 402 dashboard (shown in FIG. 24) and then selecting the treemap link. In addition, the regional manager can select “view report” 421 from the regional performance interface 402 and then selecting the treemap link.

The treemap 431 provides the regional manager a graphical presentation that allows the regional manager to quickly determine the relative performance of multiple facilities in multiple regions. As shown in FIG. 25, for example, Region 11 has multiple facilities 24 in a variety of North/Central American cities. The size of the area of a cell 433 for the particular facility indicates the relative size of the facility within the entire client organizational hierarchy. For instance, the area for the cell for the Boston facility 434 is larger than the area of a cell for the Atlanta facility 436. Thus, the regional manager can quickly determine that the Boston facility 434 has a larger overall impact than the Atlanta facility 436. The cell color is client-configurable and indicates the relative performance of the facility in comparison with other facilities on the treemap 431: in one embodiment, darker shading indicates lower performance; lighter shading indicates higher performance

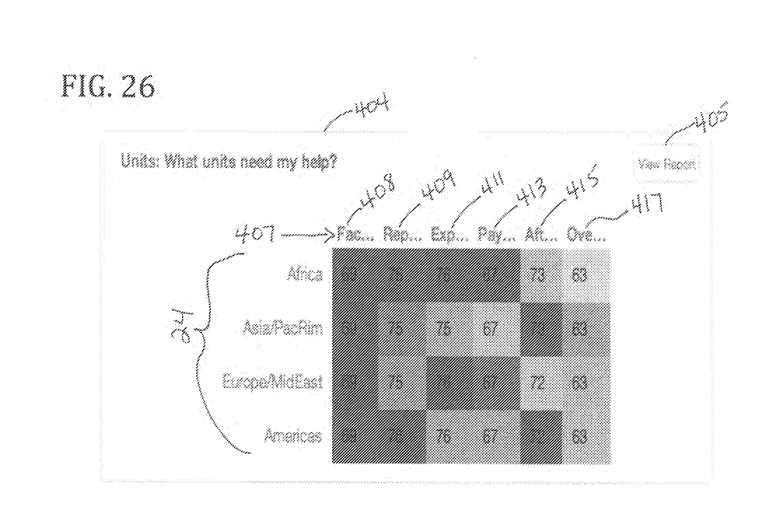

Referring now to FIG. 26, it illustrates a unit evaluation interface 404 in a second quadrant of the integrated, interactive display 22 of FIG. 23. The unit evaluation interface 404 provides the regional manager a graphical display of a “heat map” 406 illustrating the performance of a plurality of facilities 24 in a plurality of categories (e.g., performance metrics) 407 by the shading of a cell and an associated metric (e.g., performance metric) for a region.

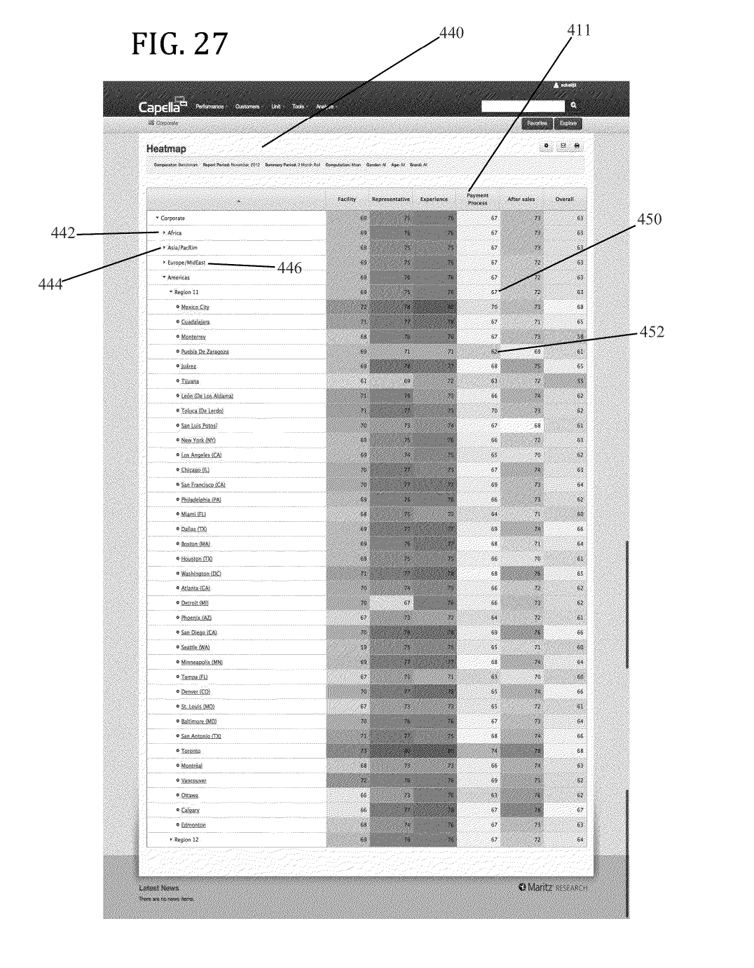

As shown, for example, the facilities 24 may not be in one region (e.g., the Africa, Asia/PacRim, Europe/MidEast, and Americas Regions are under the Corporate level; the Detroit store is in Region 11; the Hamburg store is outside the United States, and the like). Each facility on the heat map 406 has a rating for a plurality of performance metrics 407. The performance metrics 407 include a facility (Fac . . . ) metric 408, a representative (Rep . . . ) metric 409, an experience (Exp . . . ) metric 411, a payment (Pay . . . ) metric 413, a after sales (Aft . . . ) metric 415, and an OverallSatisfaction (Ove . . . ) metric 417. In addition, the unit evaluation interface 404 further provides a “View Report” 405 link that provides the regional manager a Heatmap report 440 shown in FIG. 27.

The regional manager is able to quickly determine, by looking at the heat map 406, which facilities 24 in a region are doing well and which facilities 24 need help in specific performance areas based on a color and a rating. For example, a darker color means the facility 24 is performing poorly; whereas, a lighter color means the facility 24 is performing well. A low number for a performance metric 408 means the facility 24 is performing poorly in that particular area. Thus, the combination of colors and ratings quickly inform a regional manager the performance of a facility 24 in a particular area. Also, in an embodiment, by grouping the facilities 24 in a region together on the heat map 406, a regional manager can quickly determine which facility 24 needs attention and can “drill-down” in low rated performance areas for additional information. For example, FIG. 26 shows that the Asia/PacRim region has the lowest rating for the experience metric 411. On the other hand, all of the regions have the same score for OverallSatisfaction 414.

Referring now to FIG. 27, it illustrates a more detailed “heat map” illustrating the relative performance of a plurality of facilities 24 identified by region in a plurality of categories which can be shown to the regional manager by selecting a “Heatmap” from the Unit drop-down menu or by selecting “View Report” 405 from the unit evaluation interface 404 on the integrated, interactive display 22 of FIG. 26. As shown, FIG. 27 further provides ratings based on the region (e.g., for example Africa 442, Asia/PacRim 444, and Europe/MidEast 446). The regional manager can determined based on the shading of the cell the rating number how a particular region is performing For instance, Region 11 needs assistance in Payment Process 411 (e.g., see cell 450). By examining the individual facilities 24 in the region, the regional manager can quickly determine (based on cell color and rating numbers) that the Puebla De Zaragoza store, which has a rating of 62 in Payment Process 452, is lowering the performance of the region for that particular metric.

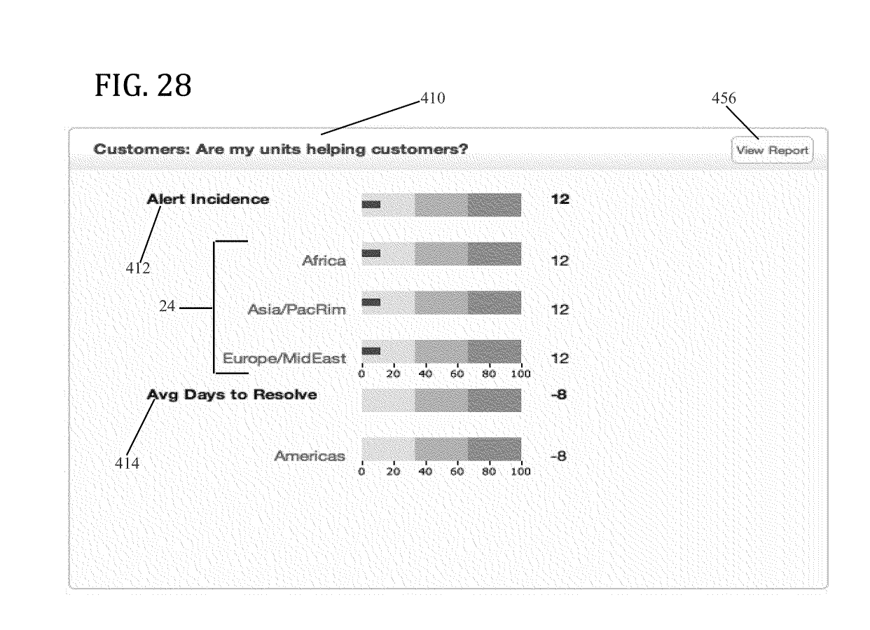

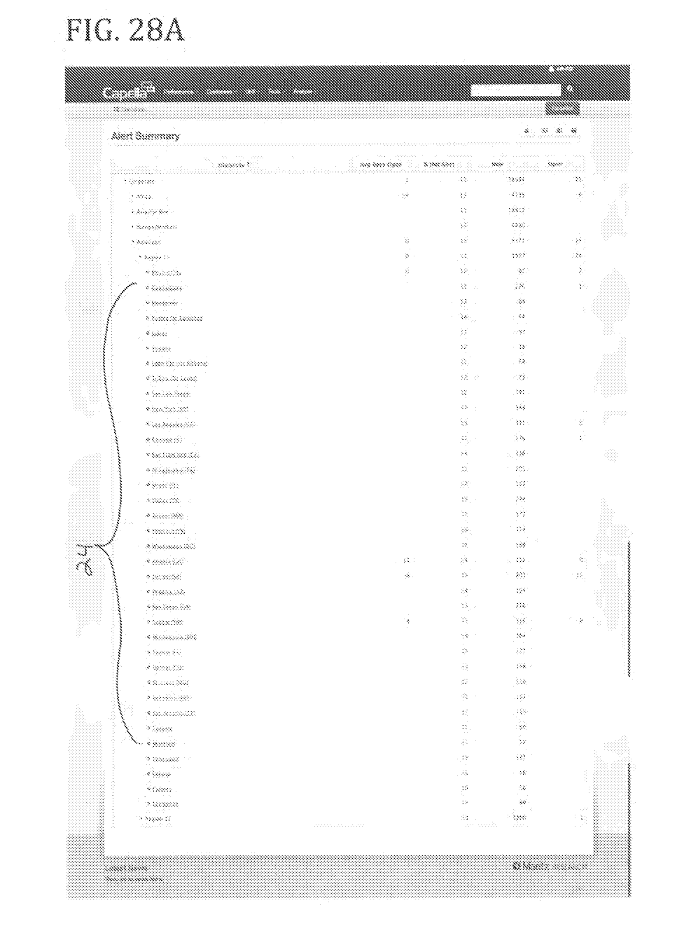

Referring now to FIG. 28, it illustrates a unit management interface 410 in the third quadrant of the Integrated, Interactive Display shown in FIG. 23, which provides a percent incidence of hot alerts 412 received for a plurality of units/facilities 24 within a particular region and an average number of days 414 each facility 24 within the region took to resolve customer issues. In addition, by selecting the View Report 456 on the unit management interface 410, a regional manager is provided with a Customers/survey alert list, as pictured in FIG. 28A. The Customers/survey alert list is also accessible to the regional manager by selecting the alert summary menu under the Customers pull-down menu.

Referring now to FIG. 28A, the Alert Summary report provides detailed information to the regional manager for each region and each facility 24 in a region as to the percentage of hot alerts. The Alerts Summary report also provides the manager the total number of new and open alerts. The regional manager is able to determine which facility 24 is therefore generating the most customer alerts and therefore needs assistance. Furthermore, by reviewing the average number days an alert is open, the regional manager can compare how efficiently the various regions are working.

Referring now to FIG. 29, it illustrates a regional priority list interface 418 in the fourth quadrant of the Integrated, Interactive Display 22 of FIG. 23. The regional priority list interface 416 graphically shows a dashboard of a bar graph 418 of critical areas of concern 420 for a particular region. In addition, the regional priority list interface 418 includes a view report link 422, which provides the regional manager with a corporate action plan by question report, illustrated in FIG. 29A. FIG. 29A illustrates the corporate action plan by question report listing each of the facilities (e.g., units) in a region and illustrating the steps in the action plan process that have been completed toward meeting a target date of completion. For example, in region 11, FIG. 29A illustrates at 419 that a Detroit unit has completed 5 steps for a starting score of 41, a current score of 41 and a target date of Jul. 10, 2013. Similarly, FIG. 29A illustrates at 421 that a Seattle unit has completed 2 steps for a starting score of 72, a current score of 72 and a target date of Sep. 12, 2013.

The corporate action plan by question report lists each of the facilities 24 (e.g., units) in a region and what step in the action plan process that was created on a particular date for the facility 24 is in to meet a target date of completion.

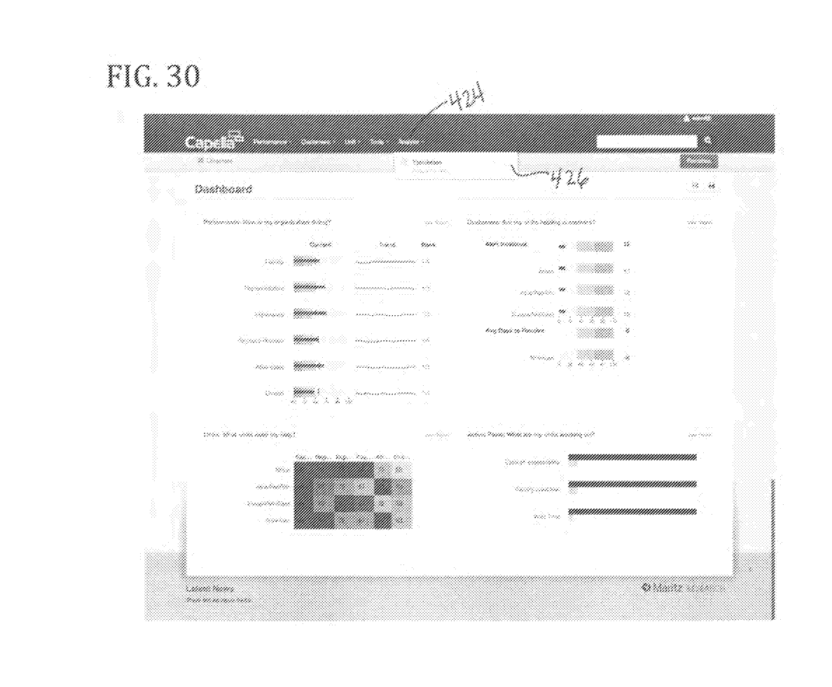

As shown in FIG. 30, the Analyze pull-down menu 424 provides the manager 60 the ability to select a Tabulation menu 426. Selecting “Tabulation” 426 from this menu 424 launches an outside software application, “Capella Tabulation”—a cross-tabulation tool that uses the same dataset as the invention.

### SUMMARY

In summary, the system 10 of the invention is for use by managers 60, employees 62, and customers 38. The system 10 is configured to analyze the experience of customers in commercial transactions involving the purchase of products/services at a facility. The system 10 combines customers' experiences to result in individual employee performance and employee team performance related to the commercial transactions.

The database 14 is populated with transactional information from multiple facilities 24 comprising transactional sales information 32 for the products/services sold, product information 30 identifying products/services available for purchase at each facility24, customer feedback information 36 regarding commercial transactions involving employees 62 made by the customer 38 when purchasing the products/services at the facility 24 and regarding a customer satisfaction of the facility 24, employee information 28 regarding the identity of each employee 62 at the facility 24 and their performance over a period of time, and facility information 26 regarding an identity of the facility 24.

The processor 12 is connected to and accesses the database 14. The processor 12 is configured to execute computer executable instructions stored in tangible, non-transitory memory 18 for presenting to the manager 60 an integrated, interactive display interface 22 (for presentation to the manager 60 on a display device such as a touch sensitive screen) comprising:

i. a facility performance interface 64,

ii. an employee evaluation interface 66,

iii. a customer management interface 68, and

iv. a priority list interface 70.

The predictor model analytic engine 52 comprises a plurality of predictor model instructions for processing the customer feedback 36 for the facility 24 to determine performance metrics of a facility 24 based on a plurality of team metrics 44 (stored in tangible, non-transitory analysis rules memory 20) over a period of time, wherein the manager 60 of a facility 24 accesses the facility performance interface 64 comprising a dashboard for graphically displaying the determined performance metrics.

The improvement analytic engine 54 comprises a plurality of improvement plan instructions for processing the employee information 28 for each employee reporting to the manager to determine employee metrics in the team based on a plurality of performance criteria 46 in selling the products/services to the customers over a period of time, wherein the manager 60 of the facility 24 accesses the employee evaluation interface 66 comprising a dashboard for graphically displaying the determined employee metrics.

The customer alert analytic engine 56 comprises a plurality of customer alert instructions for processing the product information 30 and the transactional information 32 to determine critical customer issues for the manager 60 based on customer feedback criteria 48 received from customers when purchasing the products/services, wherein the manager 60 of the facility 24 accesses the customer management interface 68 comprising a dashboard for graphically displaying the determined critical customer issues to the manager 60.

The action plan analytic engine 58 comprises a plurality of unit action plan instructions for processing the customer information 34 based on priority rules 50 to determine a plurality of ranked attributes for the team, wherein the manager 60 of the facility 24 accesses the priority list interface 70 comprising a dashboard for graphically displaying the determined ranked attributes.

Although described in connection with an exemplary computing system environment, embodiments of the invention are operational with numerous other general purpose or special purpose computing system environments or configurations. The computing system environment is not intended to suggest any limitation as to the scope of use or functionality of any aspect of the invention. Moreover, the computing system environment should not be interpreted as having any dependency or requirement relating to any one or combination of components illustrated in the exemplary operating environment.

Examples of well-known computing systems, environments, and/or configurations that may be suitable for use with aspects of the invention include, but are not limited to, personal computers, server computers, hand-held or laptop devices, multiprocessor systems, microprocessor-based systems, programmable consumer electronics, mobile telephones, tablets, network PCs, minicomputers, mainframe computers, distributed computing environments that include any of the above systems or devices, and the like.

Embodiments of the invention may be described in the general context of data and/or computer-executable instructions, such as program modules, stored one or more tangible computer storage media and executed by one or more computers or other devices. Generally, program modules include, but are not limited to, software routines, software programs, software objects, software components, and data structures that perform particular tasks or implement particular abstract data types. Aspects of the invention may also be practiced in distributed computing environments where tasks are performed by remote processing devices that are linked through a communications network. In a distributed computing environment, program modules may be located in both local and remote computer storage media including memory storage devices.

In operation, computers and/or servers may execute the computer-executable instructions such as those illustrated herein to implement aspects of the invention. For example, embodiments of the invention may be implemented with computer-executable instructions. The computer-executable instructions may be organized into one or more computer-executable components or modules on a tangible computer readable storage medium. Aspects of the invention may be implemented with any number and organization of such components or modules. For example, aspects of the invention are not limited to the specific computer-executable instructions or the specific components or modules illustrated in the figures and described herein. As used herein, instructions and/or rules mean computer executable instructions. Other embodiments of the invention may include different computer-executable instructions or components having more or less functionality than illustrated and described herein.

The order of execution or performance of the operations in embodiments of the invention illustrated and described herein is not essential, unless otherwise specified. That is, the operations may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

When introducing elements of aspects of the invention or the embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

In view of the above, it will be seen that several advantages of the invention are achieved and other advantageous results attained.

Not all of the depicted components illustrated or described may be required. In addition, some implementations and embodiments may include additional components. Variations in the arrangement and type of the components may be made without departing from the spirit or scope of the claims as set forth herein. Additional, different or fewer components may be provided and components may be combined. Alternatively or in addition, a component may be implemented by several components.

The above description illustrates the invention by way of example and not by way of limitation. This description clearly enables one skilled in the art to make and use the invention, and describes several embodiments, adaptations, variations, alternatives and uses of the invention, including what is presently believed to be the best mode of carrying out the invention. Additionally, it is to be understood that the invention is not limited in its application to the details of construction and the arrangement of components set forth in the following description or illustrated in the drawings. The invention is capable of other embodiments and of being practiced or carried out in various ways. Also, it will be understood that the phraseology and terminology used herein is for the purpose of description and should not be regarded as limiting.

Having described aspects of the invention in detail, it will be apparent that modifications and variations are possible without departing from the scope of aspects of the invention as defined in the appended claims. As various changes could be made in the above constructions, products, and methods without departing from the scope of aspects of the invention, it is intended that all matter contained in the above description and shown in the accompanying drawings shall be interpreted as illustrative and not in a limiting sense.

What is claimed is:

1. A system for use by managers, employees, and customers, the system configured to analyze the experience of customers in commercial transactions involving the purchase of products/services at a facility, the system combining customers' experiences to result in individual employee performance and employee team performance related to the commercial transactions, the system comprising:
a database populated with transactional information comprising transactional sales information for the products/services sold, product information identifying products/services available for purchase at each facility, customer feedback information regarding commercial transactions involving the facility, and facility information regarding an identity of the facility and a customer satisfaction toward the facility; and
a processor connected to and accessing the database, said processor configured for executing computer executable instructions stored in a tangible, non-transitory memory for presenting an integrated, interactive display interface comprising:
a facility performance interface,
a priority list interface;
an incentive analytic engine comprising a plurality of predictor model instructions for processing the customer feedback for the facility to determine performance metrics of the facility based on a plurality of team metrics over a period of time, wherein the manager of the facility can access the facility performance interface comprising a dashboard for graphically displaying the determined performance metrics; and
an action plan analytic engine comprising a plurality of unit action plan instructions for processing the customer information based on importance rules to determine a plurality of ranked attributes, wherein the manager of the facility accesses the priority list interface comprising a dashboard for graphically displaying the determined ranked attributes.

2. The system of claim 1, wherein the transactional information additionally comprises:
employee information regarding the identity of each employee at the facility and their performance over a period of time.

3. The system of claim 2, wherein the integrated, interactive display interface additionally comprises:
an employee evaluation interface;
a customer management interface;
an improvement analytic engine comprising a plurality of improvement plan instructions for processing the employee information for each employee reporting to the manager to determine employee metrics in the team based on a plurality of performance criteria in selling the products/services to the customers over a period of time, wherein the manager of the facility accesses the employee evaluation interface comprising a dashboard for graphically displaying the determined employee metrics; and
a customer alert analytic engine comprising a plurality of customer alert instructions for processing the product and transactional information to determine critical customer issues for the manager based on customer feedback criteria received from customers when purchasing the products/services, wherein the manager of the facility accesses the customer management interface comprising a dashboard for graphically displaying the determined critical customer issues to the manager;

4. The system of claim 3, wherein the team metrics comprise a plurality of rules for determining:
a ranking for the facility of the supervisor relative to other facilities,
a ranking of all the salespersons in the supervisor's team relative to other salespersons at other facilities,
a customer rating for the facility based on a plurality of customer ratings from customers that have purchased a product/service at the facility relative to a customer rating for other facilities,
a customer payment experience rating for the facility based on a plurality of customer payment ratings from customers that have purchased a product/service at the facility relative to the a customer payment experience rating for other facilities,
a customer product/service delivery rating for the facility based on a plurality of customer product/service delivery ratings from customers that have purchased a product/service at the facility relative to a customer product/service delivery rating for other facilities,
a customer likely to return rating for the facility based on a plurality of customer likely to return ratings from customers that have purchased a product/service at the facility relative to a customer likely to return rating for other facilities, and
a customer overall satisfaction rating for the facility based on a plurality of customer overall satisfaction ratings from customers that have purchased a product/service at the facility relative to a customer overall satisfaction rating for other facilities.

5. The system of claim 4, wherein instructions for the salespersons ranking comprises instructions for processing a composite ranking of all salespersons in the team for a facility based on a ranking of each salesperson in the facility relative to all salespersons at a plurality of facilities.

6. The system of claim 4, wherein instructions for the customer acquisition rating for the facility comprise instructions for processing a plurality of customer acquisition ratings when purchasing a product/service at the facility, the customer acquisition rating based on a rating for ease of purchase, a rating for time to pay, and a rating for price fairness when the customer purchased a product/service at the facility.

7. The system of claim 1, wherein instructions for the facility performance interface further comprise instructions for processing a distribution of a plurality of rankings for a plurality of facilities, wherein the distribution displays a rank for each facility relative to the rank of all other facilities.

8. The system of claim 1, wherein instructions for the facility performance interface further comprise instructions for processing a distribution of team rankings for a facility, wherein the distribution displays a rank for each team relative to the rank of all other teams at the facility.

9. The system of claim 1, wherein instructions for the facility performance interface further comprise instructions for processing trend information for a facility over a period of time relative to benchmark information over the same time period, wherein the trend information is the ranking of the facility relative to the ranking of all other facilities over the period of time.

10. The system of claim 3, wherein instructions for the employee evaluation interface comprise instructions for displaying an employee performance, the employee performance providing to the supervisor a ranking for each employee on the team ranking below a predetermined level in selling the products/services to the customer relative to all other employees on the team in selling the products/services to the customer, trend information for each underperforming employee based on a benchmark in selling the products/services to customers over a period of time, and a comparison of a current status of the underperforming employee on the team of the supervisor in selling the products/services to the customer compared to a status goal for the team of the supervisor in selling the products/services to the customer.

11. The system of claim 10, wherein instructions for displaying the employee performance comprises:
instructions for the supervisor to select an underperforming employee;
instructions for displaying for the selected underperforming employee a plurality of rankings in a plurality of areas compared to all employees on the team of the supervisor; and
instructions for displaying the employee performance for the selected underperforming employee in critical areas selected by the supervisor.

12. The system of claim 11 wherein instructions for displaying the employee performance for the selected underperforming employee further comprises instructions for displaying a ranking for the selected underperforming employee relative to all other employees on the team of the supervisor in each critical area selected by the supervisor.

13. The system of claim 10, wherein instructions for displaying the employee performance further comprise instructions for displaying a plurality of supervisor-employee interfaces, wherein the supervisor-employee interfaces include an action step interface for the supervisor to select a plurality of actions/tasks for the selected employee to undertake based on a plurality of attributes listed in an attributes interface to help the employee increase their performance, a self-assessment interface for the employee to comment on the plurality of actions/tasks selected by the supervisor, an attributes interface that displays a predetermined list of actions/tasks a supervisor may select for an employee, and a manager assessment interface for the supervisor to comment based on the comments of the employee in the self-assessment interface.

14. The system of claim 3, wherein the improvement plan instructions comprise:
instructions for the supervisor to review ratings for each employee in the team on at least one of:
a knowledge rating for the employee,
a professionalism rating for the employee,
a customer concern rating for the employee,
correctness rating for the employee,
a knowledge of product/service rating for the employee,
a sales tactics rating for the employee,
a rating for fairness in payment terms rating,
a rating of an explanation of paperwork by the employee,
a rating of an explanation of product features by the employee,
a rating of how the employee treated customers in selling the product/service,
a rating of whether the employee indicated concern for a customer finances when selling the product/service, and
a rating of the employee in explaining a purchase process when selling the product/service.

15. The system of claim 14, wherein the instructions for rating the sales tactics rating comprises:
instructions for a rating of a sales pressure a customer perceives by an employee when selling a product/service to a customer,
instructions for a rating of a pace of sale a customer perceives by an employee when selling a product/service to a customer,
instructions for a rating of the employee for offering payment options to a customer when the employee is selling a product/service to the customer,
instructions for a rating of the employee for working in the customer's interest when selling a product/service to a customer,
instructions for a rating of the employee for answering questions by a customer when selling a product/service to the customer, and
instructions for a rating of a pace of purchase a customer perceives by an employee when selling a product/service to a customer.

16. The system of claim 3, wherein the instructions for the customer management interface comprise:
instructions for displaying to a supervisor a total number of critical customer issues for the supervisor to review;
instructions for categorizing the total number of critical customer issues as at least one of a new issue, an open issue and a pending issue; and
instructions for displaying a current status of the categorized critical customer issues.

17. The system of claim 16, wherein instructions for the customer management interface further comprise instructions for a supervisor to display at least one of a survey detail interface, a case management interface, and a hot alert list interface.

18. The system of claim 17, wherein the instructions for displaying the survey detail interface to the supervisor comprise instructions for processing a client name interface, instructions for processing a facility rating interface, instructions for processing an overall experience interface, instructions for processing a product/service delivery rating interface, instructions for processing a salesperson rating interface, and instructions for processing a payment experience rating interface.

19. The system of claim 17, wherein the instructions for displaying the case management interface to the supervisor comprise instructions for processing assigning the critical customer issue to an employee by the supervisor, wherein the assigning comprises a specific action for the employee and a target date for the employee to complete the action.

20. The system of claim 1, wherein instructions for displaying the priority list interface to the supervisor comprise instructions for displaying to the supervisor a category of the critical customer issue, instructions for displaying to the supervisor a name of a customer associated with the critical customer issue, instructions for displaying to the supervisor a customer rating associated with the critical customer issue, instructions for displaying to the supervisor a date the critical customer issue was filed by a customer, instructions for displaying to the supervisor a number of days the critical customer issue has been open, and instructions for displaying to the supervisor an employee the critical customer issue has been assigned.

21. The system of claim 3 wherein instructions for the priority list interface further comprises instructions for displaying an action planning tool, the action planning tool comprising a name of a prioritized task selected by the supervisor, a type of task, an identification of team members assigned to the task, a current status of the task, and a date the task was last updated.

22. The system of claim 3, wherein instructions for the priority list interface further comprises instructions for displaying a critical items interface.

23. The system of claim 22, wherein instructions for the critical items interface comprises instructions for processing a histogram ranking of the team at a facility compared to other units in the region/organization, instructions for displaying a trend chart comparing team performance over a period of time to a benchmark goal, and instructions for displaying a list of a plurality of employees performance metrics regarding the attribute.

24. The system of claim 3 wherein the predictor model instructions further comprise instructions for the manager to adjust at least one of a performance attribute for the facility to predict performance on a given dependent variable.

25. The system of claim 3 wherein the improvement plan instructions further comprise instructions for the manager to select at least one of an employee summary report for a particular employee and a performance plan tool from the employee evaluation interface.

26. The system of claim 3 wherein the customer alert instructions further comprise instructions for the manager to select at least one of a survey/alert list report and a case management tool from the customer management interface.

27. The system of claim 3 wherein the action plan instructions further comprise instructions for the manager to select at least one of an action planning tracking report to assign tasks to the team and an action planning tool from the priority plan interface.

28. One or more computer-readable storage media having computer-executable components stored on the tangible, non-transitory media to provide a system for use by managers, employees, and customers to analyze the experience of customers in commercial transactions involving the purchase of products/services at a facility, the system including:
a database populated with transactional information comprising transactional sales information for the products/services sold, product information identifying products/services available for purchase at each facility, customer feedback information regarding commercial transactions involving employees made by the customer when purchasing the products/services at the facility, employee information regarding the identity of each employee at the facility and their performance for a transaction, and facility information regarding an identity of the facility and a customer satisfaction toward the facility, and
a processor connected to and accessing the database, said processor configured for executing the computer executable components for presenting an integrated, interactive display interface, said computer-executable components comprising:
a facility performance interface component comprising a plurality of computer-executable predictor model instructions for processing the customer feedback for the facility to determine performance metrics of the facility based on a plurality of team metrics over a period of time for presenting a facility performance interface on the integrated, interactive display interface, wherein the manager of the facility can access the facility performance interface comprising a dashboard for graphically displaying the determined performance metrics;
an employee evaluation interface component comprising a plurality of computer-executable improvement plan instructions for processing the employee information for each employee reporting to determine employee metrics in the team based on a plurality of performance criteria in selling the products/services to the customers over a period of time for presenting an employee evaluation interface on the integrated, interactive display interface, wherein the manager of the facility accesses the employee evaluation interface comprising a dashboard for graphically displaying the determined employee metrics;
a customer management interface component comprising a plurality of computer-executable customer alert instructions for processing the product and transactional information to determine critical customer issues based on customer feedback criteria received from customers when purchasing the products/services for presenting a customer management interface on the integrated, interactive display interface, wherein the manager of the facility accesses the customer management interface comprising a dashboard for graphically displaying the determined critical customer issues; and
a priority list interface component comprising a plurality of computer-executable unit action plan instructions for processing the customer information based on priority rules to determine a plurality of ranked attributes for the team for presenting a priority list interface on the integrated, interactive display interface, wherein the manager of the facility accesses the priority list interface comprising a dashboard for graphically displaying the determined ranked attributes.

29. One or more computer-readable storage media having computer-executable instructions stored on the tangible, non-transitory media for use with a system including a database populated with:
transactional information comprising transactional sales information for products/services sold,
product information identifying products/services available for purchase at various facilities,
customer feedback information regarding commercial transactions involving employees made by customers when purchasing the products/services at a facility,
employee information regarding the identity of each employee at a facility and their performance over a period of time, and
facility information regarding an identity of a facility and a customer satisfaction toward the facility;
the system including a processor connected to and accessing the database, said processor configured for executing said computer executable instructions, said instructions comprising:
instructions for presenting an integrated, interactive display interface comprising:
a facility performance interface,
an employee evaluation interface,
a customer management interface, and
a priority list interface;
an incentive analytic engine comprising a plurality of predictor model instructions for processing the customer feedback for each facility to determine performance metrics of the facility based on a plurality of team metrics over a period of time, wherein a manager of the facility can access the facility performance interface comprising a dashboard for graphically displaying the determined performance metrics;
an improvement analytic engine comprising a plurality of improvement plan instructions for processing the employee information for each employee to determine employee metrics in the team based on a plurality of performance criteria in selling the products/services to the customers over a period of time, wherein a manager of the facility accesses the employee evaluation interface comprising a dashboard for graphically displaying the determined employee metrics;
a customer alert analytic engine comprising a plurality of customer alert instructions for processing the product and transactional information to determine critical customer issues based on customer feedback criteria received from customers when purchasing the products/services, wherein a manager of the facility accesses the customer management interface comprising a dashboard for graphically displaying the determined critical customer issues; and
an action plan analytic engine comprising a plurality of unit action plan instructions for processing the customer information based on priority rules to determine a plurality of ranked attributes for the team, wherein a manager of the facility accesses the priority list interface comprising a dashboard for graphically displaying the determined ranked attributes.
